(19) United States
(12) Patent Application Publication
(10) Pub. No.: US 2015/0174741 A1
(43) Pub. Date: Jun. 25, 2015

(54) ADJUSTABLE WRENCHES, PLIERS, AND SHEARS

(71) Applicant: Joshua W. Frank, Sedona, AZ (US)

(72) Inventor: Joshua W. Frank, Sedona, AZ (US)

(21) Appl. No.: 14/575,820

(22) Filed: Dec. 18, 2014

Related U.S. Application Data
(60) Provisional application No. 61/918,631, filed on Dec. 19, 2013.

(51) Int. Cl. B25B 13/14; B26B 13/26; B25J 1/04; B25B 13/46

(52) U.S. Cl. CPC B25B 13/14; B25B 13/461; B26B 13/26; B25J 1/04

(57) ABSTRACT

A hand tool includes a fixture having an adjustable working end and an opposing handle. The handle is rotated to the fixture. A transmission couples the handle to the adjustable working end, whereby rotation of the handle urges corresponding adjustment of the adjustable working end. The working end includes an end section, and a wrench insert rotated to the end section, or co-acting movable jaws mounted to the end section.

### CROSS REFERENCE TO RELATED APPLICATION

This application claims the benefit of U.S. Provisional Patent Application Ser. No. 61/918,631, filed Dec. 19, 2013, the entire contents of which are expressly incorporated by reference herein.

### FIELD OF THE INVENTION

The present invention relates to tools and, more particularly, to hand tools, including wrenches, pliers, and cutters.

### BACKGROUND OF THE INVENTION

A hand tool is any tool that is not a power tool and which is operated by hand. Of particular significance are wrenches, pliers, and cutters. The prior art is replete with hand-operated wrenches and pliers suitable for grasping, twisting or rotating nuts and bolts, and hand-operated shears. Common wrench designs include the crescent wrench and the ratchet style wrench, including ratchet style socket and box wrenches. The crescent wrench, also called a spanner wrench, the most common type of adjustable wrench, includes a stationary jaw and a co-acting movable jaw that is adjusted with a finger screw to set the span of the jaws to the given bolt head or nut. A common ratchet style wrench includes a socket or a ring spanner or box that is placed about a nut or a bolt and then rotated by the reciprocating movement of a ratchet handle to rotate the nut or bolt in a preselected direction. The ratcheting or pawl mechanism of the ratchet handle can be adjusted for facilitating rotation of the socket or ring spanner in a selected direction. Pliers include co-acting jaws joined at a fulcrum and that are opened and closed with handle on the opposite side of the fulcrum. Similar to pliers, shears include co-acting jaws including two crossed pivoted blades that cut by shearing action, with handles, often ring-shaped handles, at one end.

Although existing adjustable wrenches, pliers, and shears are suitable for most operations, they can be difficult or impossible to use when the item to be worked on with the wrench or pliers, such as the given nut or bolt, or the object to be cut with the shears, is in an area that is difficult to reach or provides insufficient clearance to allow use of the given hand tool according to its intended use. The present invention achieves this and provides artisans with adjustable hand tools that are easy to construct and easy to employ in tight and hard to reach areas and that incorporate features that provide a mechanical advantage in their operation.

### SUMMARY OF THE INVENTION

According to the principle of the invention, a hand tool includes a fixture having a handle, an opposing adjustable working end, and a drive member mounted for adjustment to the fixture. A transmission couples the drive member to the adjustable working end, whereby adjustment of the drive member relative to the handle urges corresponding adjustment of the adjustable working end. The drive member is between the handle, and the adjustable working end. The drive member is disposed for adjustment by hand while gripping the handle. The transmission is enclosed within the fixture.

According to the principle of the invention, a hand tool includes a fixture having a handle, an opposing adjustable working end, and a drive member rotated to the fixture. A transmission couples the drive member to the adjustable working end, whereby rotation of the drive member relative to the handle urges corresponding adjustment of the adjustable working end. The drive member is between the handle, and the adjustable working end. The drive member is disposed for rotation by hand while gripping the handle. The transmission includes a shaft coupled between a first gear assembly coupled to the adjustable working end and a second gear assembly coupled to the drive member. The first gear assembly includes a screw mounted to the shaft coupled to at least one gear of the adjustable working end in meshing engagement. The second gear assembly includes a gear of the shaft coupled to a ring gear of the drive member in meshing engagement. The drive member and the ring gear circumscribe the fixture. The transmission is enclosed within the fixture.

According to the principle of the invention, a hand tool includes a fixture having a handle and an opposing adjustable working end. A drive member and a driven member are each mounted for adjustment to the fixture. The driven member is coupled to the adjustable working end, whereby adjustment of the driven member urges corresponding adjustment of the adjustable working end. A transmission couples the drive member to the driven member, whereby adjustment of the drive member urges corresponding adjustment of the driven member. The drive member is between the handle, and the adjustable working end. The drive member is disposed for adjustment by hand while gripping the handle. The transmission is enclosed within the fixture.

According to the principle of the invention, a hand tool includes a fixture having a handle and an opposing adjustable working end. A drive member and a driven member are each rotated to the fixture. The driven member is coupled to the adjustable working end, whereby rotation of the driven member urges corresponding adjustment of the adjustable working end. A transmission couples the drive member to the driven member, whereby rotation of the drive member urges corresponding rotation of the driven member. The drive member is between the handle, and the adjustable working end. The drive member is disposed for rotation by hand while gripping the handle. The transmission includes a shaft coupled between the driven member and a gear assembly coupled to the drive member. The driven member is a screw coupled to at least one gear of the adjustable working end in meshing engagement. The gear assembly includes a drive gear of the shaft coupled to a ring gear of the drive member in meshing engagement. The drive member and the ring gear circumscribe the fixture. The transmission is enclosed within the fixture.

According to the principle of the invention, a hand tool includes a fixture having an adjustable working end and an opposing handle mounted for adjustment to the fixture, and a transmission coupling the handle to the adjustable working end, whereby adjustment of the handle urges corresponding adjustment of the adjustable working end. The handle circumscribes the fixture.

According to the principle of the invention, a hand tool includes a fixture having an adjustable working end and an opposing handle rotated to the fixture, and a transmission coupling the handle to the adjustable working end, whereby rotation of the handle urges corresponding adjustment of the adjustable working end. The transmission includes a shaft coupled between the handle and a gear assembly coupled to the adjustable working end. The gear assembly includes a screw mounted to the shaft coupled to at least one gear of the adjustable working end in meshing engagement. The handle circumscribes the fixture. The transmission is enclosed within the fixture.

According to the principle of the invention, a hand tool includes a fixture having a handle, and an opposing stationary jaw. A co-acting movable jaw is mounted to the fixture. A drive member and a driven member are each rotated to the fixture. The driven member is coupled to the co-acting movable jaw, whereby rotation of the driven member urges corresponding movement of the co-acting movable jaw. The drive member is coupled to the driven member, whereby rotation of the drive member urges corresponding rotation of the driven member. The drive member is between the handle, and the stationary and co-acting movable jaws. The drive member is disposed for rotation by hand while gripping the handle. A rack is carried by the co-acting movable jaw, a first gear is coupled to the rack in meshing engagement, the drive member includes a ring gear, the driven member is a screw, and a shaft has a second gear coupled to the ring gear in meshing engagement, and the screw coupled to the first gear in meshing engagement. The drive member and the ring gear of the drive member circumscribe the fixture. The transmission is enclosed within the fixture.

According to the principle of the invention, a hand tool includes a handle rotated to a fixture having an end section, a wrench insert rotated to the end section, and a driven member rotated to the end section. The driven member is coupled the wrench insert, whereby rotation of the driven member urges corresponding rotation of the wrench insert. The handle is coupled to the driven member, whereby rotation of the handle urges corresponding rotation of the driven member. A shaft couples the handle to the driven member, whereby rotation of the handle urges corresponding rotation of the shaft, which, in turn, urges the corresponding rotation of the driven member. A drive planetary gear assembly is coupled between the shaft and the handle. The drive planetary gear assembly including a drive sun gear carried by the shaft, a plurality of drive planet gears coupled to the drive sun gear in meshing engagement, and a drive ring gear, coupled to the handle, in meshing engagement with the plurality of drive planet gears. The handle circumscribes the fixture and is disposed for rotation by hand. The shaft extends through the fixture from the driven member to the handle. The driven member is a screw coupled to a gear of the wrench insert in meshing engagement. The shaft is enclosed within the fixture.

According to the principle of the invention, a hand tool includes a handle rotated to a fixture having an end section, co-acting movable jaws mounted to the end section, and a driven member rotated to the end section. The driven member is coupled the co-acting movable jaws, whereby rotation of the driven member urges corresponding movement of the co-acting movable jaws. The handle is coupled to the driven member, whereby rotation of the handle urges corresponding rotation of the driven member. A shaft couples the handle to the driven member, in which rotation of the handle urges corresponding rotation of the shaft, which, in turn, urges the corresponding rotation of the driven member. The handle circumscribes the fixture and is disposed for rotation by hand. The shaft extends through the fixture from the driven member to the handle. The driven member is a screw coupled to a gear of each one of the co-acting movable jaws in meshing engagement. The shaft is enclosed within the fixture.

According to the principle of the invention, a hand tool includes a fixture having a handle and an opposing end section, co-acting movable jaws mounted to the end section, and a drive member and a driven member each rotated to the fixture. The driven member is coupled to the co-acting movable jaws, whereby rotation of the driven member urges corresponding movement of the co-acting movable jaws. The drive member is coupled to the driven member, whereby rotation of the drive member urges corresponding rotation of the driven member. The drive member is between the handle, and the co-acting movable jaws. The drive member is disposed for rotation by hand while gripping the handle. The drive member includes a ring gear, the driven member is a screw, and a shaft has a second gear coupled to the ring gear in meshing engagement, and the screw coupled to a gear of each one of the co-acting movable jaws in meshing engagement. The drive member and ring gear circumscribe the fixture. The shaft is enclosed within the fixture.

Consistent with the foregoing summary of illustrative embodiments, and the ensuing detailed description, which are to be taken together, the invention also contemplates associated apparatus and method embodiments.

### BRIEF DESCRIPTION OF THE DRAWINGS

Referring to the drawings:

FIGS. 1 and 2 are perspective views of an adjustable wrench constructed and arranged in accordance with the invention;

FIG. 3 is a side elevation view of the embodiment of FIGS. 1 and 2, the opposite side elevation view being the same thereof;

FIG. 4 is a top plan view of the embodiment of FIGS. 1 and 2;

FIG. 5 is a section view taken along line 5-5 of FIG. 4 illustrating a transmission coupled between a drive member and a movable jaw of the adjustable working end of the wrench;

FIG. 6 is a perspective view corresponding to FIG. 5 illustrating the transmission, the drive member, and the adjustable working end of the wrench;

FIG. 7 is a perspective view of a low profile adjustable wrench constructed and arranged in accordance with the invention;

FIG. 8 is a side elevation view of the embodiment of FIG. 7, the opposite side elevation view being the same thereof;

FIG. 9 is a section view taken along line 9-9 of FIG. 7;

FIG. 10 is an enlarged, partially exploded perspective view of the embodiment of FIG. 7, illustrating a wrench insert aligned with a working end of the low profile adjustable wrench in preparation for installation therein;

FIGS. 11 and 12 are perspective views of the wrench insert of FIG. 10;

FIG. 13 is a side elevation view of the wrench insert of FIG. 10;

FIGS. 14-16 are perspective views of an alternate embodiment of a wrench insert for use with the embodiment of FIG. 7;

FIG. 17 is an enlarged fragmented view of a rear end of the embodiment of FIG. 7;

FIG. 18 is a perspective view illustrating a handled implement coupled to the rear end of FIG. 17, the handled implement including handles pivoted to a base, the handles shown deployed in preparation for use;

FIG. 19 is a side elevation view of the embodiment of FIG. 18;

FIG. 20 is a view similar to that of FIG. 19 illustrating the handles pivoted forwardly from their deployed positions in FIGS. 18 and 19;

FIG. 21 is a view corresponding to FIG. 18 illustrating one of the handles deployed and the other one of the handles pivoted forwardly into a storage position;

FIG. 22 is a perspective view of another embodiment of a low profile adjustable wrench constructed and arranged in accordance with the invention;

FIG. 23 is an exploded perspective view of the embodiment of FIG. 22;

FIG. 24 is an enlarged perspective view of a wrench insert of the embodiment of FIG. 23;

FIG. 25 is an enlarged perspective view of an alternate embodiment of a wrench insert for use with the embodiment of FIG. 24;

FIG. 26 is a perspective view of yet another alternate embodiment of a low profile adjustable wrench constructed and arranged in accordance with the invention;

FIG. 27 is a section view taken along line 27-27 of FIG. 26;

FIG. 28 is yet a further alternate embodiment of a low profile adjustable wrench corresponding to the embodiment of FIG. 26;

FIG. 29 is a perspective view of still a further embodiment of a low profile adjustable wrench constructed and arranged in accordance with the invention, including a working end pivoted to a fixture and shown as it would appear in a central or intermediate position;

FIGS. 30 and 31 are perspective views corresponding to FIG. 29 illustrating the working end pivoted to either side of the intermediate position illustrated in FIG. 29;

FIG. 32 is a section view taken along line 32-32 of FIG. 29;

FIG. 33 is a section view taken along line 33-33 of FIG. 30;

FIG. 34 is yet a further alternate embodiment of a low profile adjustable wrench corresponding to the embodiment of FIG. 29;

FIG. 35 is a perspective view of pliers in accordance with the invention;

FIG. 36 is a section view taken along line 36-36 of FIG. 35;

FIG. 37 is an enlarged side elevation view of a working end of the pliers of FIG. 35;

FIG. 38 is a section view of the working end of the pliers of FIG. 35;

FIG. 39 is an enlarged perspective view of a co-acting jaw of the pliers of FIG. 35;

FIG. 40 is an enlarged perspective view of the working end of the pliers of FIG. 35 shown as it would appear closed;

FIG. 41 is a view corresponding to FIG. 40 with the working end shown as it would appear open;

FIGS. 42-44 illustrate alternate embodiments of pliers according to the invention;

FIGS. 45 and 46 illustrate cutting blades in place of pliers jaws of the working end of the embodiment of FIG. 35, FIG. 44 showing the cutting blades open and FIG. 45 showing cutting blades closed;

FIGS. 47 and 48 illustrate cutting blades in place of pliers jaws of the working end of the embodiment of FIG. 43, FIG. 47 showing the cutting blades open and FIG. 48 showing cutting blades closed; and

FIG. 49 illustrates cutting blades in place of pliers jaws of the working end of the embodiment of FIG. 44.

### DETAILED DESCRIPTION

### §1. Adjustable Wrenches

### A

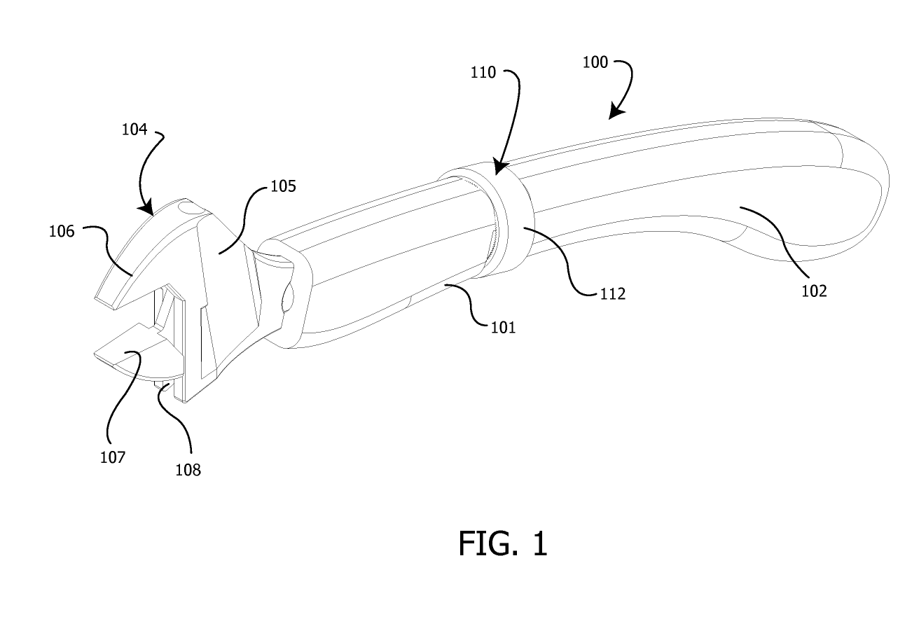

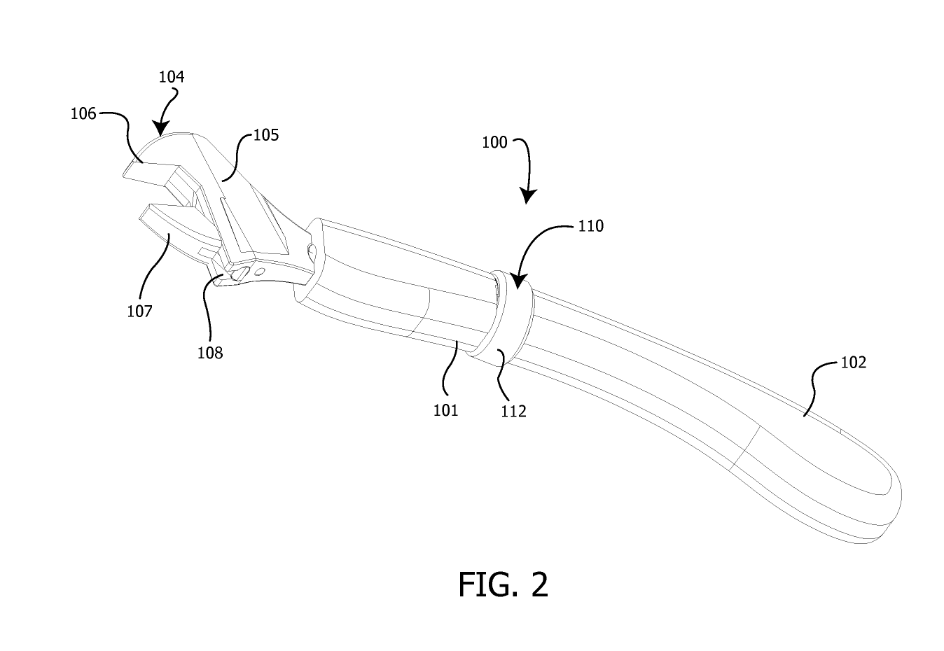

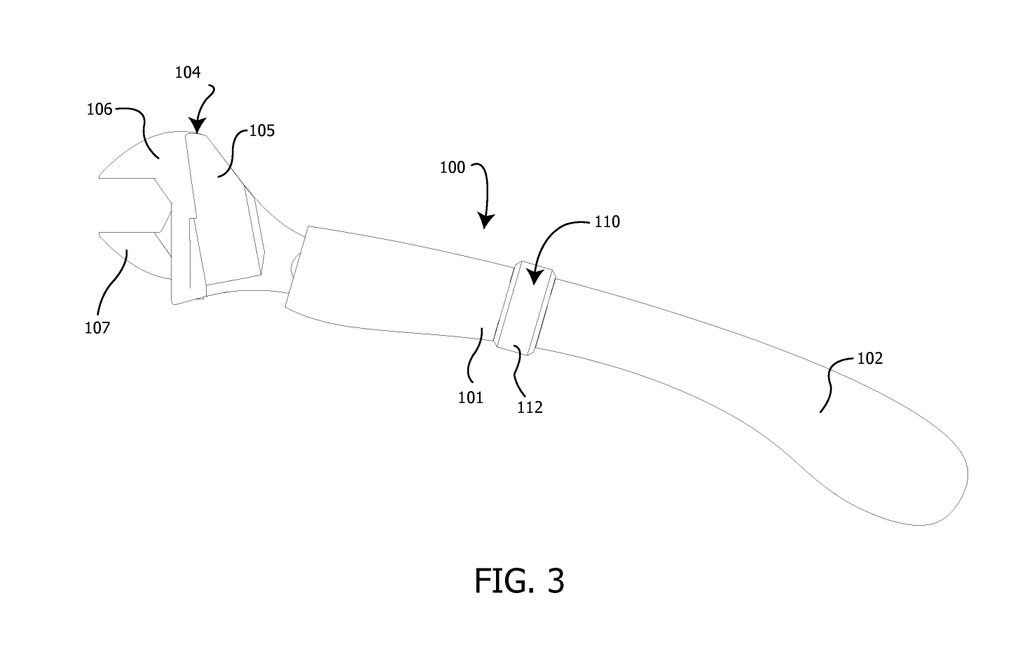

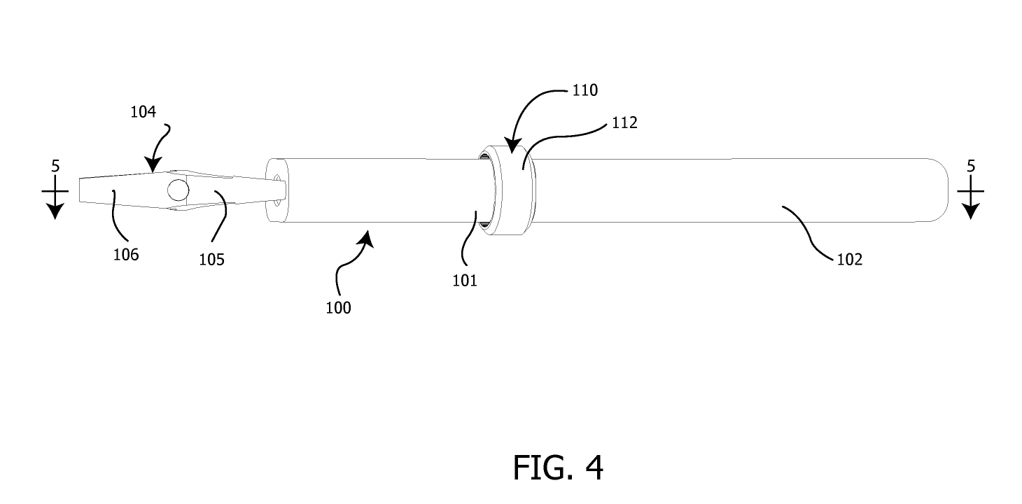

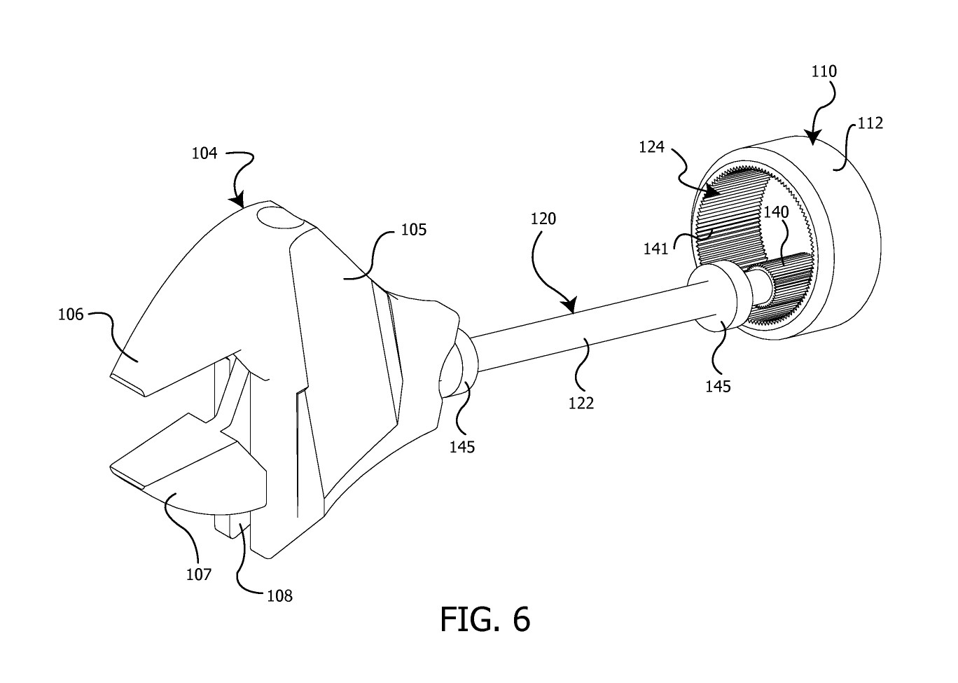

FIGS. 1-5 illustrate an adjustable wrench 100 useful for loosening and tightening nuts and bolts of varying sizes, as well as the gripping of pipes and other objects of varying size. Adjustable wrench 100 is formed of forged steel or an equivalent strong durable material. Adjustable wrench 100, which is an adjustable crescent wrench, is a hand tool and includes elongate fixture 101 having a rearward handle 102 and an opposing forward working end 104 for gripping nuts, bolts, etc. Handle 102 is stationary and does not move. In FIGS. 1-3 and 5, working end 104 is adjustable and includes head 105 of fixture 101 formed with stationary jaw 106, and a co-acting movable jaw 107 mounted to head 105 of fixture 101. Movable jaw 107 is mounted to head 105 for movement in reciprocal directions relative to stationary jaw 106 for adjusting the span between the gripping surfaces of stationary and movable jaws 106 and 107. Movable jaw 107 is a sliding jaw, typical for crescent wrenches, being mounted for sliding reciprocal movement in track 108 formed in head 105 shown in FIGS. 1, 2, 5, and 6.

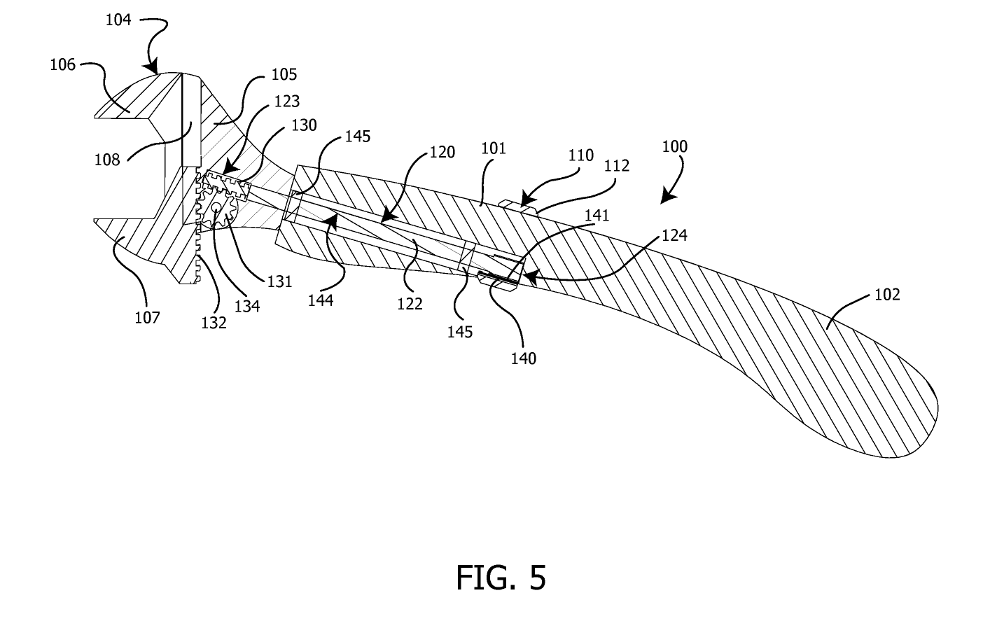

Adjustable wrench 100 includes a drive member 110, and transmission 120, which couples drive member 110 to movable jaw 107. Drive member 110 is mounted for adjustment to fixture 101. Handle 102 is a stationary handle, and drive member 110 is adjustable relative to handle 102. Transmission 120 is coupled between drive member 110 and movable jaw 107, and transfers power from drive member 110 to movable jaw 107 for moving movable jaw 107 in reciprocal directions relative to stationary jaw 106. The coupling of transmission 120 to drive member 110 and to the movable part of working end 194, movable jaw 107, is an operative coupling, whereby adjustment of drive member 110 urges corresponding adjustment of working end 104, namely, the corresponding movement of movable jaw 107 in reciprocal directions relative to stationary jaw 106. And so in FIG. 5, transmission 120 couples drive member 110 to movable jaw 107 of working end 104, whereby adjustment of drive member 110 urges corresponding adjustment of working end 104, namely, the corresponding movement of movable jaw 107 in reciprocal directions relative to stationary jaw 106. In a further and more specific aspect, drive member 110 is rotated to fixture 101 for rotational movement/adjustment, and transmission 120 couples drive member 110 to movable jaw 107 of working end 104, whereby rotation of drive member 110 urges corresponding adjustment of working end 104, namely, the corresponding movement of movable jaw 107 in reciprocal directions relative to stationary jaw 106.

In FIGS. 1-5, drive member 110 is mounted to fixture 101 between handle 102, and stationary and co-acting movable jaws 104 and 105. Beneficially, drive member 110 is disposed for rotation by hand while gripping stationary handle 102. Drive member 110 is an annular member 112. Annular member 112, a collar, encircles or circumscribes fixture 101, and extends circumferentially outward from fixture 101 being thus disposed for rotation by hand, such as with the thumb and forefinger, while gripping handle 102.

In FIG. 5, transmission 120 includes a shaft 122 coupled between gear assembly 123 coupled to working end 104 and gear assembly 124 coupled to drive member 110. Shaft 122 includes screw 130 at its forward end, and drive gear 140 at its rearward end. Gear assembly 123 includes screw 130 coupled to gear 131 in meshing engagement which, in turn, is coupled to rack 132 of movable jaw 107 in meshing engagement. Gear assembly 124 includes a drive gear 140 of shaft 122 coupled to a ring gear 141 of drive member 110, which is disposed on the inner diameter of annular member 112 of drive member 110 circumferentially facing fixture 101. Screw 130, a gear, specifically a worm gear, is the driven member of transmission 120, which is driven by drive member 110. Transmission 120 is enclosed in fixture 101, from the junction between drive gear 140 and ring gear 141 of gear assembly 124 to screw 130 and gear 131 of gear assembly 123 and to the junction between gear 131 and rack 132.

In FIG. 5, rack 132 is a gear formed by a plurality of gear teeth formed in the inner end of movable jaw 107. Gear 131, a pinion enclosed in head 105 behind rack 132, is rotated to head 105 with a pin 134, and is coupled to rack 132 in meshing engagement. Rack 132 and gear 131 are illustrative of a rack-and-pinion gear assembly. With gear 131 coupled to rack 132 in meshing engagement, rotation of gear 131 urges corresponding movement of movable jaw 107 in reciprocal directions relative to stationary jaw 106, in which rotation of gear 131 in one direction urges corresponding movement of movable jaw 107 toward stationary jaw 106, and rotation of gear 131 in the opposite direction urges corresponding movement of movable jaw 107 away from stationary jaw 106. The reciprocal movement of movable jaw 107 relative to stationary jaw 106 allows adjustment of the span between the gripping surfaces the respective jaws 106 and 107.

Shaft 122, an elongate member or rod for transmitting motion, includes screw 130 at its forward end and drive gear 140 at its rearward end, all of which are located and enclosed in channel 144 within fixture 101, which extends from head 105 to drive member 110. Shaft 122 is rotated to bushings, bushings 145 encircle shaft 122 and are coupled between shaft 122 and channel 144 and hold shaft 122 in channel 144, and shaft 122 can rotate in channel 144. Shaft 122 is thus rotated to fixture 101 in channel 144, which, in turn, concurrently rotates screw 130 to fixture 101 at the forward end of shaft 122 and rotates drive gear 140 to fixture 101 at the rearward end of shaft 122. Shaft 122, including screw 130 and drive gear 140, gear 131, and the junction between drive gear 140 and ring gear 141, are enclosed in channel 144, and the junction between gear 131 and rack 132 are enclosed between movable jaw 107 and head 105. Lubrication, such as a lubricating oil or grease, can be applied in channel 144 to lubricate gear assemblies 123 and 124 and shaft 122. Screw 130 and drive gear 140 rotate concurrently with the rotation of shaft 122, screw 130 is coupled to gear 131 in meshing engagement, and drive gear 140 is coupled to ring gear 141 in meshing engagement. Gear 131 operatively couples screw 130 to rack 132 of movable jaw 107, whereby rotation of screw 130 urges corresponding rotation of gear 131 for, in turn, imparting corresponding reciprocal movement to movable jaw 107. Rotation of drive member 110 concurrently rotates ring gear 141 as the two are formed together. Rotation of ring gear 141 urges corresponding rotation of drive gear 140 at the rearward end of shaft 122 which, in turn, rotates shaft 122 which rotates screw 130. Rotation of screw 130 imparts corresponding rotation to gear 131 for adjusting working end 104, namely, moving movable jaw 107 in reciprocal directions relative to stationary jaw 106. And so drive gear 140, ring gear 141 and shaft 112 operatively couple drive member 110 to screw 130, the driven member of transmission 120, which, in turn, is operatively coupled to movable jaw 107 of working end 104 with gear 131 and rack 132, whereby rotation of drive member 110 urges corresponding rotation of screw 130 for rotating gear 131 for, in turn, adjusting working end 104, namely, urging movement of movable jaw 107 in reciprocal directions relative to stationary jaw 106. Rotation of drive member 110 in one direction, such as the clockwise direction, urges movable jaw 107 toward stationary jaw 106, and rotation of drive member 110 in the opposite direction, the counterclockwise direction, urges movable jaw 107 away from stationary jaw 106.

And so adjustable wrench 100 includes fixture 101 having handle 102, opposing working end 104, and drive member 110 mounted for adjustment to fixture 101. Transmission 120 operatively couples drive member 110 to movable jaw 107 of working end 104, in which adjustment of drive member 110 relative to handle 102 urges corresponding adjustment of working end 104, namely, the movement of movable jaw 107 in reciprocal directions relative to stationary jaw 106. More specifically, drive member 110 is rotated to fixture 101 and transmission 120 operatively couples drive member 110 to movable jaw 107 of working end 104, in which rotation of drive member 110 relative to handle 102 urges corresponding adjustment of working end 104, namely, the movement of movable jaw 107 in reciprocal directions relative to stationary jaw 106.

In yet a further aspect, adjustable wrench 100 includes fixture 101 having handle 102 and opposing working end 104, drive member 110 mounted for adjustment to fixture 191, and screw 130, the driven member of transmission 120, mounted for adjustment to fixture 101. The driven member, screw 130, is operatively coupled to movable jaw 107 of working end 104, in which adjustment of the driven member, screw 130, urges corresponding adjustment of working end 104, namely, the movement of movable jaw 107 in reciprocal directions relative to stationary jaw 106. Transmission 120 operatively couples drive member 110 to the driven member, screw 130, in which adjustment of drive member 110 urges corresponding adjustment of the driven member, screw 130. More specifically, drive member 110 mounted for rotation to fixture 191, and screw 130, the driven member of transmission 120, is mounted for rotation to fixture 101. The driven member, screw 130, is operatively coupled to movable jaw 107 of working end 104, in which rotation of the driven member, screw 130, urges corresponding adjustment of working end 104, namely, the movement of movable jaw 107 in reciprocal directions relative to stationary jaw 106. Transmission 120 operatively couples drive member 110 to the driven member, screw 130, in which rotation of drive member 110 urges corresponding rotation of the driven member, screw 130.

In adjustable wrench 100, drive member 110 is mounted to fixture 101 between handle 102 and working end 104, so a user can adjust the span between jaws 106 and 107 simply rotating drive member 110 by hand, such as with the thumb and forefinger, while concurrently gripping handle 102. While handle 102 remains in the user's hand, the user may enlist his thumb and forefinger to rotate drive member 110 to adjust the span between jaws 106 and 107 to accommodate fasteners, pipes, etc., of varying sizes. Like a conventional crescent wrench, radial motion is applied in order to loosen or tighten the fastener or otherwise act on the given work piece held between jaws 106 and 107. The span between jaws 106 and 107 is adjustable regardless of clearance, without having to release handle 102, and without having to disengage the fastener or given work piece.

The ability to adjust the span between jaws 106 and 107 from a natural gripping position gripping handle 102 by hand with the thumb and forefinger aids in the prevention of stripped fasteners and provides a mechanical advantage which allows for efficient jaw adjustment, and allows the user to adjust adjustable wrench 100 with his thumb and forefinger enabling one-handed operation. These mechanics provide an unprecedented level of accuracy and accessibility and grip on the fastener or work piece, and can be applied to other embodiments, including a pipe wrench, plumber's wrench, monkey wrench, and the like. Adjustable wrench 100 does not have an exposed thumb screw at rack 132 of movable jaw 107. Instead the transmission 120 that transfers power from drive member 110 to movable jaw 107 for moving movable jaw 107 in reciprocal directions relative to stationary jaw 106 is enclosed in fixture 101 and can be lubricated and can be finely tuned to eliminate the inherently loose jaws typical of conventional adjustable wrenches. At any given point, when rotation of drive member 110, jaws 106 and 107 are automatically locked into the current position via the meshing coupling of screw 130 to gear 131 and gear 131 to rack 132.

### B

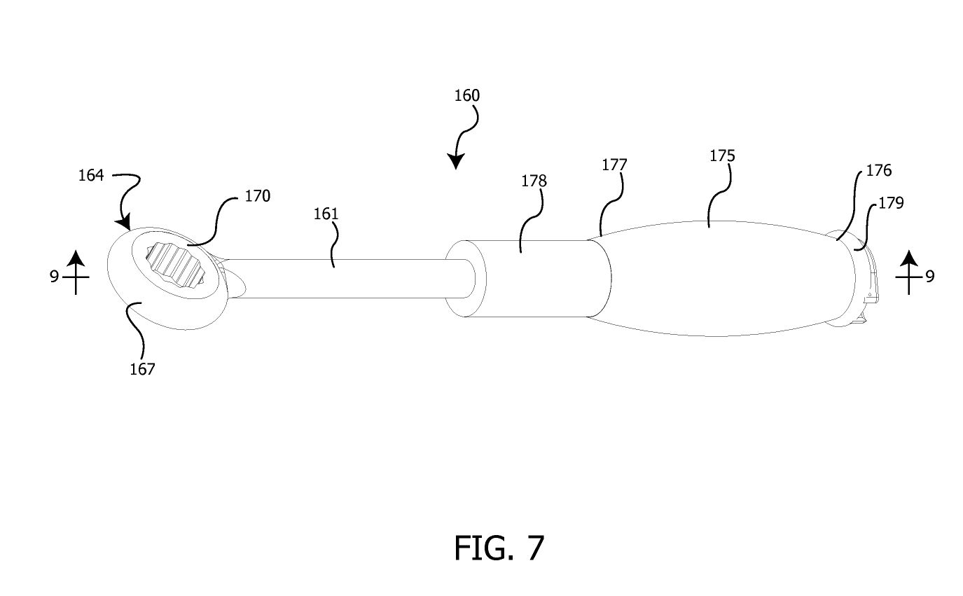

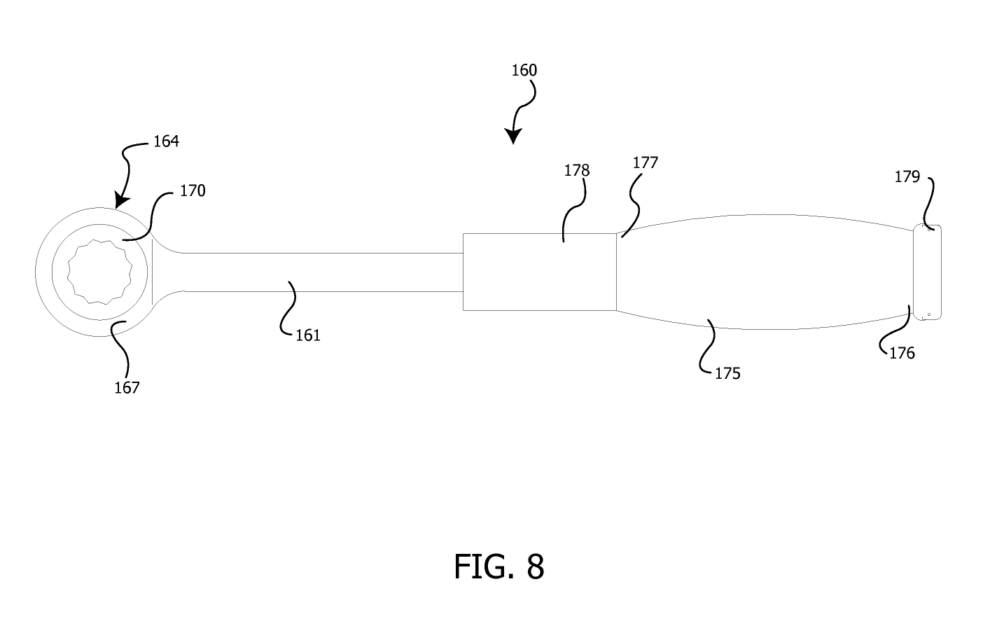

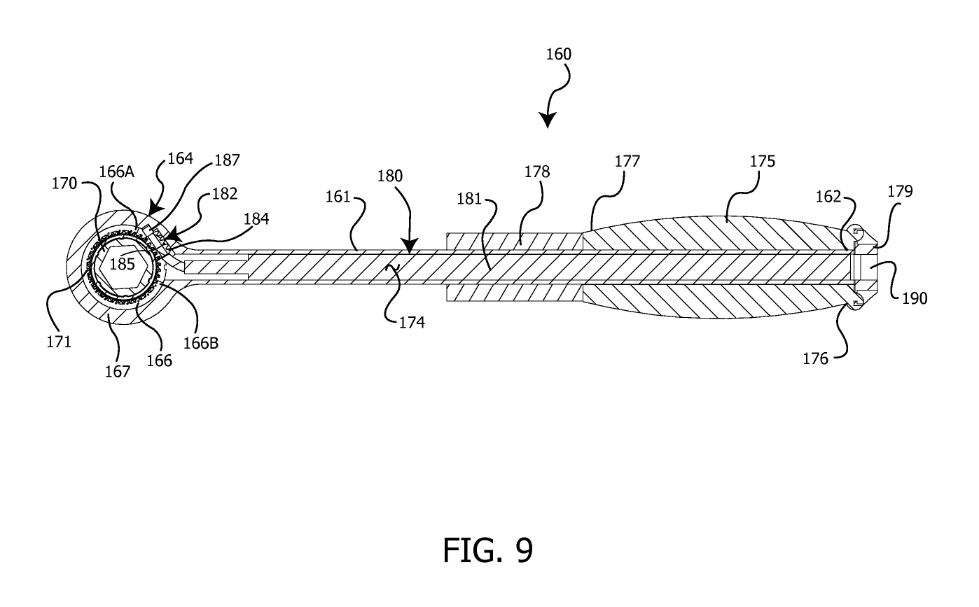

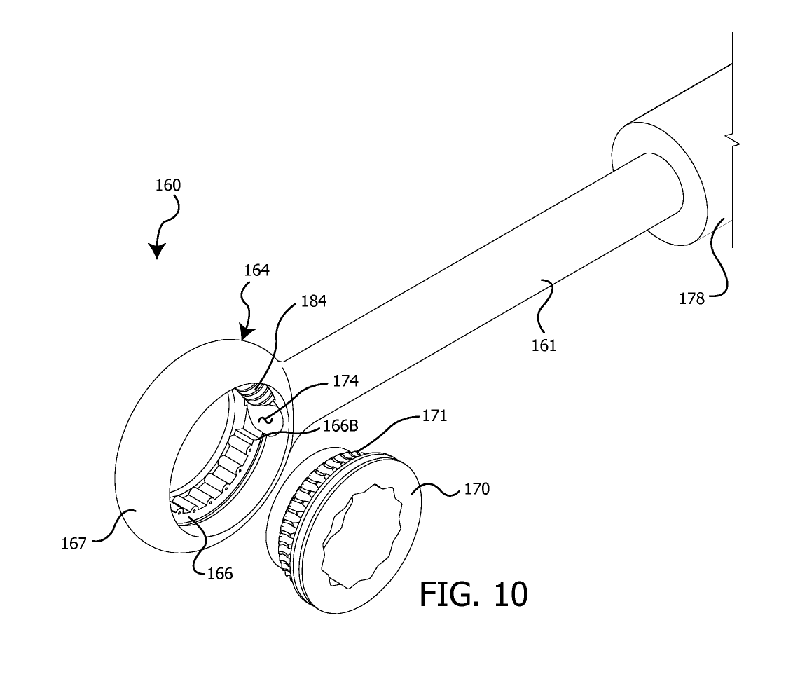

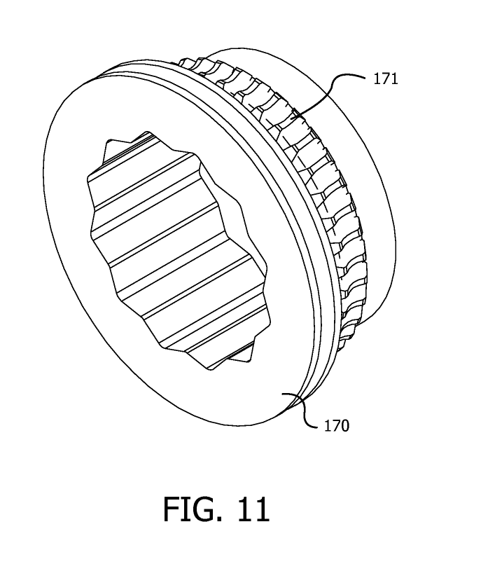

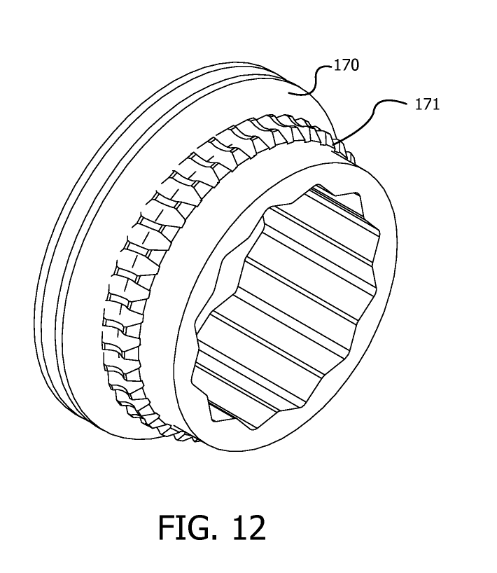

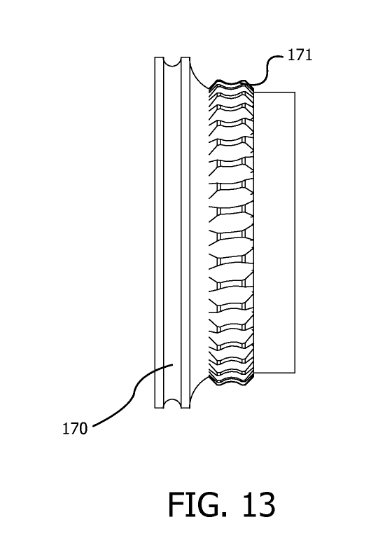

FIGS. 7-9 illustrate a low-profile adjustable wrench 160 useful for loosening and tightening nuts and bolts of varying sizes. Adjustable wrench 160 is formed of forged steel or an equivalent strong durable material. Adjustable wrench 160, which is an adjustable ring spanner or box wrench, is a hand tool and includes elongate fixture 161 having a rear end 162 and an opposing forward working end 164. Working end 164 is adjustable. In FIG. 9 and FIG. 10, working end 164 is adjustable and includes a C-shaped bearing 166 captively retained in a box 167, which is an annular body that is open on either side. A wrench insert 170 is inserted into box 167 and is retained for rotation therein by bearing 166. In FIGS. 10-12, wrench insert 170, which has an exterior circumferential gear 171, is a socket, a hollow cylinder that fits over the end of a nut or bolt head. Fixture 161 is elongate and straight, and is cylindrical in shape from near to working end 164 to rear end 162. Fixture 161 is hollow, in which channel 174 extends through fixture 161 from box 167 of working end 164 to rear end 162. Channel 174 is open to box 167.

Fixture 161 carries handle 175. Handle 175 opposes working end 164, and is mounted for adjustment to fixture 161. In FIG. 9, transmission 180 couples handle 175 to wrench insert 170. Transmission is coupled between handle 175 and working end 164, and transfers power from handle 175 to working end 164 for rotating wrench insert 170. The coupling of transmission 180 to handle 175 and to the movable part of working end 164, the wrench insert 170, is an operative coupling, whereby adjustment of handle 175 urges corresponding adjustment of working end 164, namely, the corresponding rotation of wrench insert 170. And so transmission 180 couples handle 175 to wrench insert 170 of working end 164, whereby adjustment of handle 175 urges corresponding adjustment of working end 164, namely, the corresponding rotation of wrench insert 170. In a further and more specific aspect, handle 175 is rotated to fixture 161 for rotational movement/adjustment, and transmission 180 couples handle 175 to wrench insert 170 of working end 164, whereby rotation of handle 175 urges corresponding adjustment of working end 164, namely, the corresponding rotation of wrench insert 170.

In FIG. 9, handle 175 has a rear end 176 and an opposing front end 177, encircles or otherwise circumscribes fixture 161, and rotates about fixture 161. Rear end 176 of handle 175 and rear end 162 of fixture 161 are juxtaposed, and handle 175 extends forwardly along fixture 161 from rear end 176 at rear end 162 of fixture 161 to front end 177 of handle 175 disposed at an intermediate location along the length of fixture 161 between rear end 162 and working end 164. A stationary grip 178 encircles or otherwise circumscribes fixture 161 forward of handle 175 between front end 177 of handle 175 and working end 164, and is received up against front end 177 of handle 175. Handle 175 has end cap 179, which is affixed to rear end 176 of handle 175 and extends over rear end 162 of fixture 161. Beneficially, handle 175 is disposed for rotation by hand while gripping handle 175. If desired, a user my grip stationary grip 178 with one hand, and rotate handle 175 with his other hand.

Transmission includes a shaft 181 coupled between handle 175 and a gear assembly 182 coupled to working end 164. Shaft 181, an elongate member or rod for transmitting motion, is enclosed in fixture 161 and extends through channel 174 from a screw 184 at its forward end at box 167 to its rearward end rigidly affixed to end cap 179, such as by welding, a press fit, or other rigid coupling. Shaft 181 is enclosed in channel 174. Screw 184, a gear, specifically a worm gear, is tangential to circumferential gear 171 of wrench insert 170, and is coupled to circumferential gear 171 in meshing engagement. Screw 184 and circumferential gear 171 form gear assembly 182. Screw 184 resides in recess 185 formed in the inner diameter of box 167 at a gap between opposed free ends 166A and 166B of bearing 166. Screw 184 is affixed to and circumscribes a flexible segment 186, such as flexible cord, that extends tangentially into box 167 through the gap between free ends 166A and 166B of bearing 166 from the forward end of shaft 181. The outer end of flexible segment 186 on the far side of screw 184 is rotated in fitting 187 rigidly affixed to a counter-recess of recess 185. Flexible segment 186 is an extension of shaft 181 and is considered a part of shaft 181. Flexible segment 186 is affixed to the forward end of shaft 181, such as by welding or a press-fit engagement. Shaft 181 can rotate in channel 174. Screw 184 is the driven member of transmission 180, which is driven by handle 175, which is the drive member of transmission 180.

Shaft 181 is thus rotated to fixture 161 in channel 174, which, in turn, concurrently rotates screw 184 to working end 164 of fixture 161 at the forward end of shaft 181. Shaft 181 rotates about an axis that is parallel to and concentric with respect to the length of fixture 161 from near working end 164 to rear end 162. Working end 164 is centered along the axis of rotation of shaft 181, as opposed to being offset as discussed below in an alternate embodiment. Lubrication, such as a lubricating oil or grease, can be applied in channel 174 and recess 185 to shaft 181 and gear assembly 182, respectively. Screw 184 rotates concurrently with the rotation of shaft 181, and the inherently flexible property of flexible segment 186 allows flexible segment 186 to constantly flex as it rotates. The coupling of flexible segment 186 between the forward end of shaft 181 and fitting 187 retain screw 184 in place. The meshing engagement of screw 184 to circumferential gear 171 operatively couples screw 184 to wrench insert 170, the movable part of working end 164, whereby rotation of screw 184 urges corresponding rotation of wrench insert 170. Rotation of handle 175 concurrently rotates shaft 181 which rotates screw 184. Rotation of screw 184 imparts corresponding rotation to wrench insert 170, and the rotation of wrench insert 170 is considered to be an adjustment of working end 164. And so shaft 181, enclosed in fixture 161, operatively couples handle 175 to screw 184, the driven member of transmission 180, which, in turn, is operatively coupled to the movable component of working end 164, wrench insert 170, whereby rotation of handle 175 urges corresponding rotation of screw 184 for rotating wrench insert 170. Rotation of handle 175 in one direction, such as the clockwise direction, urges rotation of wrench insert 170 in first direction, and rotation of handle 175 in the opposite direction, the counterclockwise direction, urges rotation of wrench insert 170 in the opposite direction.

So adjustable wrench 160 includes fixture 161 having working end 164 and opposing handle 175 mounted for adjustment to fixture 161, and transmission 180 that couples handle 175 to working end 164 and, more specifically, the movable part of working end, namely, wrench insert 170. Transmission 180 operatively couples handle 175 to the movable part of working end 164, wrench insert 170, in which adjustment of handle 175 urges corresponding adjustment of working end 164, namely, the rotation of wrench insert 170. More specifically, handle is 175 rotated to fixture 161 and transmission 180 operatively couples handle 175 to wrench insert 170 of working end 164, in which rotation of handle 175 urges corresponding adjustment of working end 164, namely, the rotation of wrench insert 170.

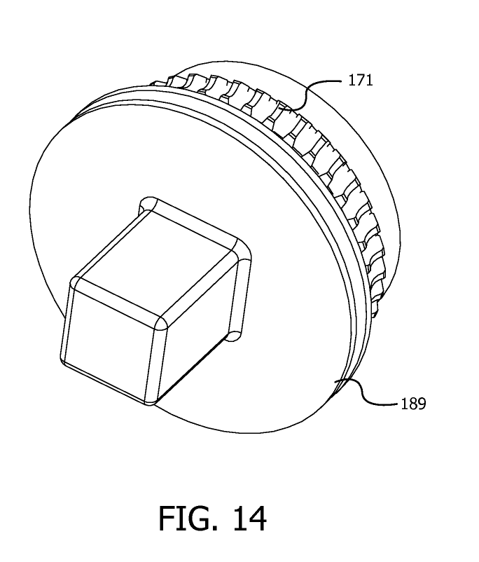

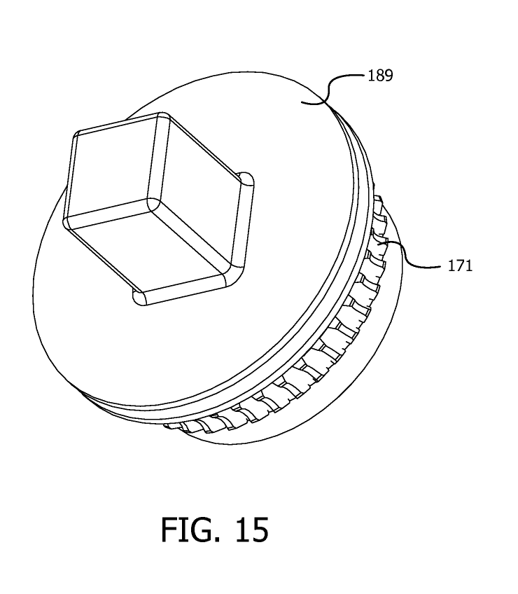

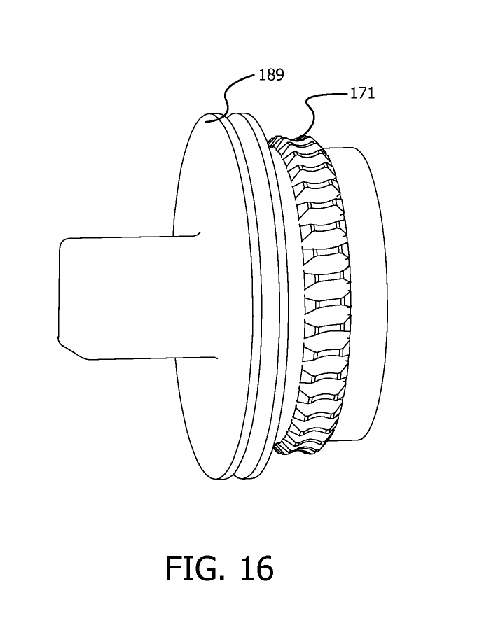

Adjustable wrench 160 can be operated in areas that lack space to properly use conventional wrenches. Adjustable wrench 160 is particularly well suited for application that require hand tightened fasteners. By twisting rotating handle 175 adjustable wrench 160 mechanically rotates wrench insert 170 to rotate a fastener inserted into wrench insert 170. The user can then use adjustable wrench 160 in a radial motion, apart from twisting rotating handle 175, to apply desired leverage or torque. Whereas, common wrenches work solely in a radial motion, adjustable wrench works in a radial motion and from twisting rotating handle 175. Handle 175 can have a ratchet action in order to eliminate the necessity of releasing and repositioning the user's hand on the rotating handle 175. Again, handle 175 is disposed for rotation by hand while gripping handle 175, and a user my grip stationary grip 178 with one hand for stability, and rotate handle 175 with his other hand. In FIGS. 10-12, wrench insert 170, which is a modular insert, is a socket, a hollow cylinder that fits over the end of a nut or bolt head. Wrench insert 170 can have any preselected dimension. Other modular wrench inserts can be used having various preselected dimensions or mechanical structure for any fastener requiring mechanical rotation, such as screwdriver head, a hex wrench, etc. An example of such a modular wrench insert is denoted by the reference character 189 in FIGS. 14-16. In FIGS. 14-16, wrench insert 189 has the same circumferential gear 171 as wrench insert 170, but rather than having a socket is a driver having a key for reception into a corresponding keyway of another wrench insert, such as a socket. Other selected wrench inserts can be used with adjustable wrench 160 without departing from the invention.

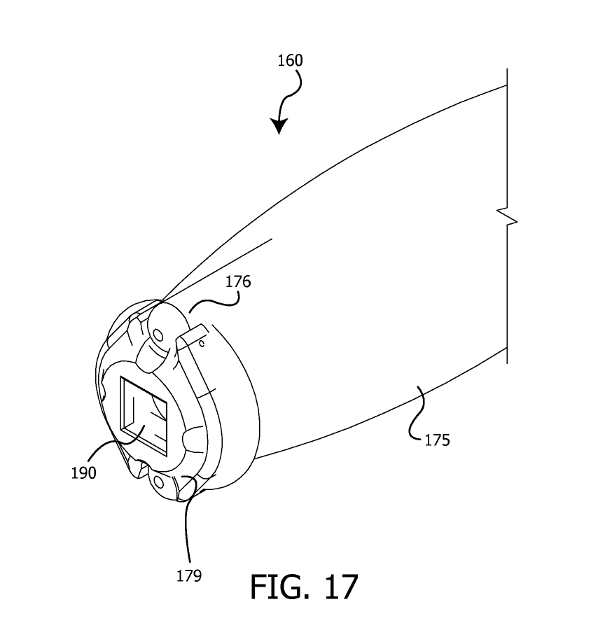

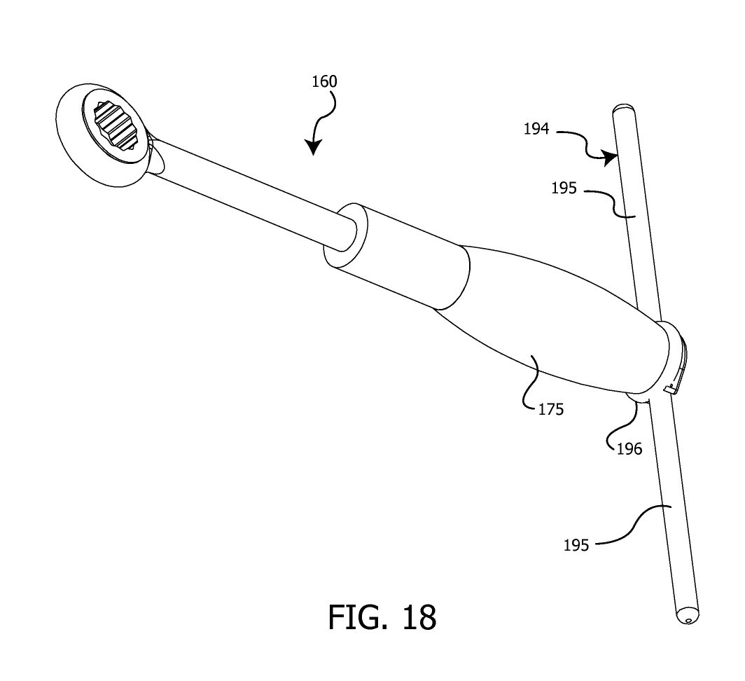

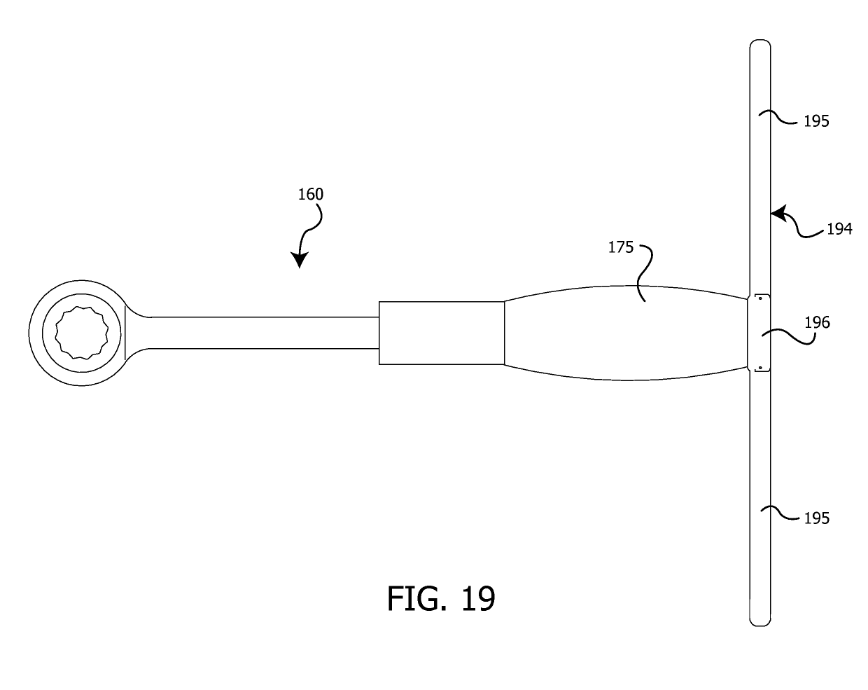

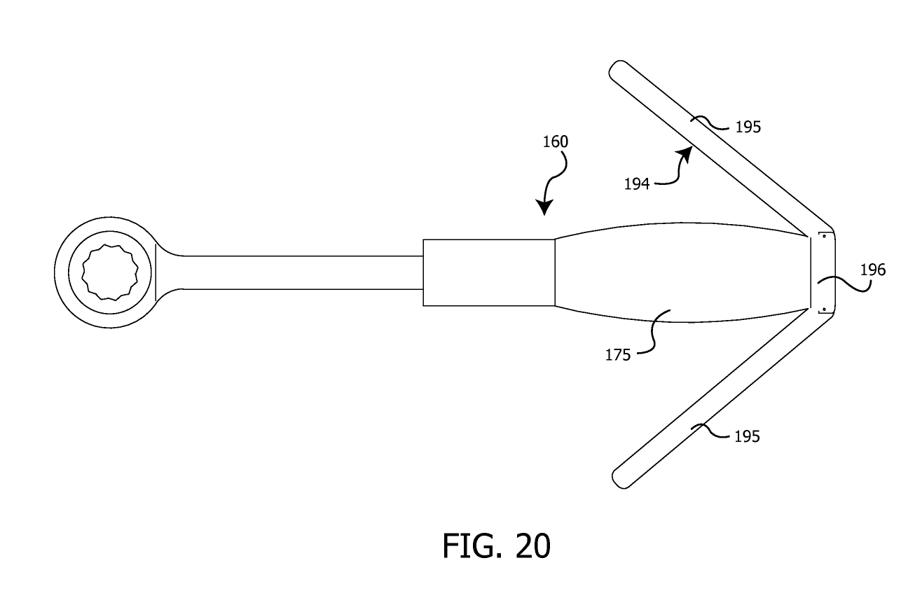

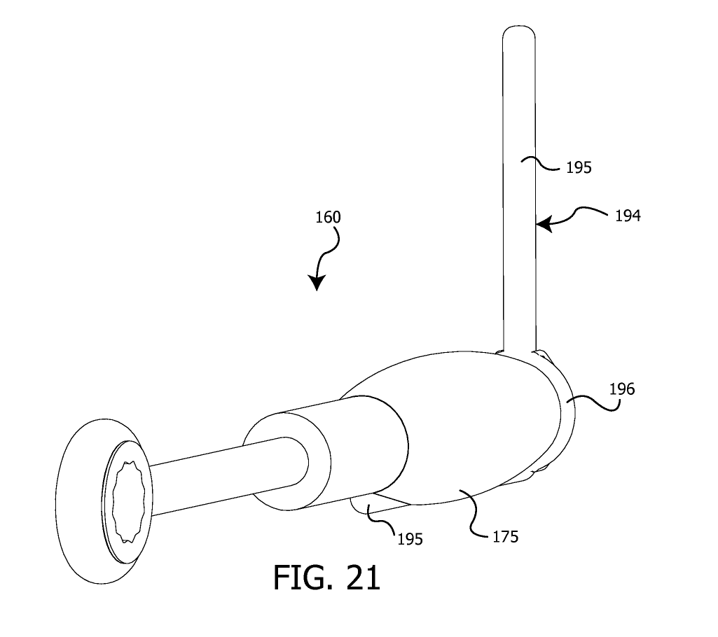

In FIG. 17, end cap 179 is formed with a socket 190, which can accept the key of a handle or handled implement for aiding a user in rotating handle 175. A socket wrench can be used for this purpose simply by inserting the key of the socket wrench into socket 190 and then working the socket wrench in a radial motion. A socket driver of an impact wrench or other motorized or mechanized driver can also be inserted into socket 190 and used to drive handle 175 for rotation. Other handled implements can be used. As a matter of example, FIGS. 18 and 19 illustrate a handled implement 194 coupled to end cap 179 formed in rear end 176 of handle 175. In this example, handled implement 194 includes handles 195 pivoted to a base 196 connected to end cap 179 in the manner previously described. Handles 195 can be taken up by hand and used to rotate handle 175. FIG. 20 illustrates handles 195 pivoted forwardly, such as for storage. FIG. 21 illustrates one handle 196 deployed for use in rotating handle 175, and the other handle 196 pivoted forwardly into a storage position.

### C

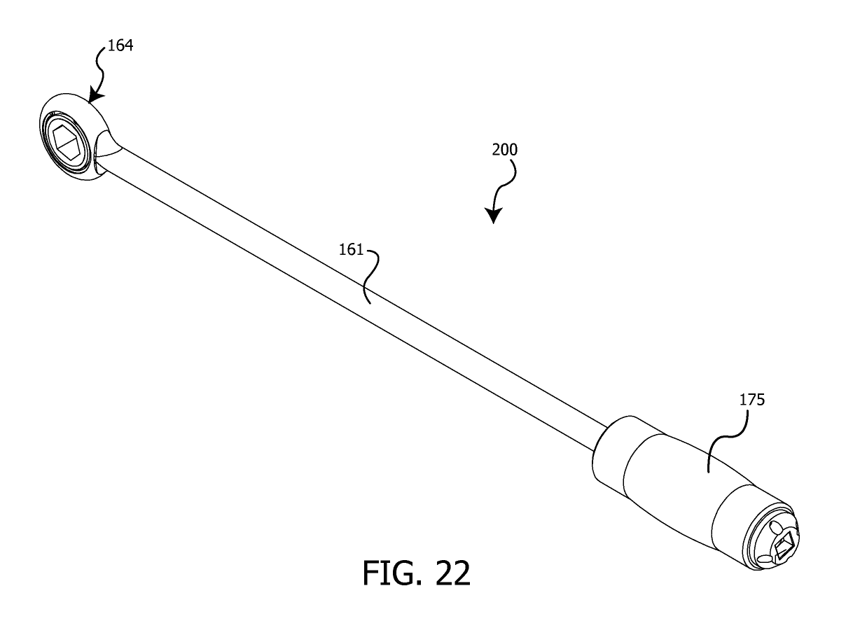

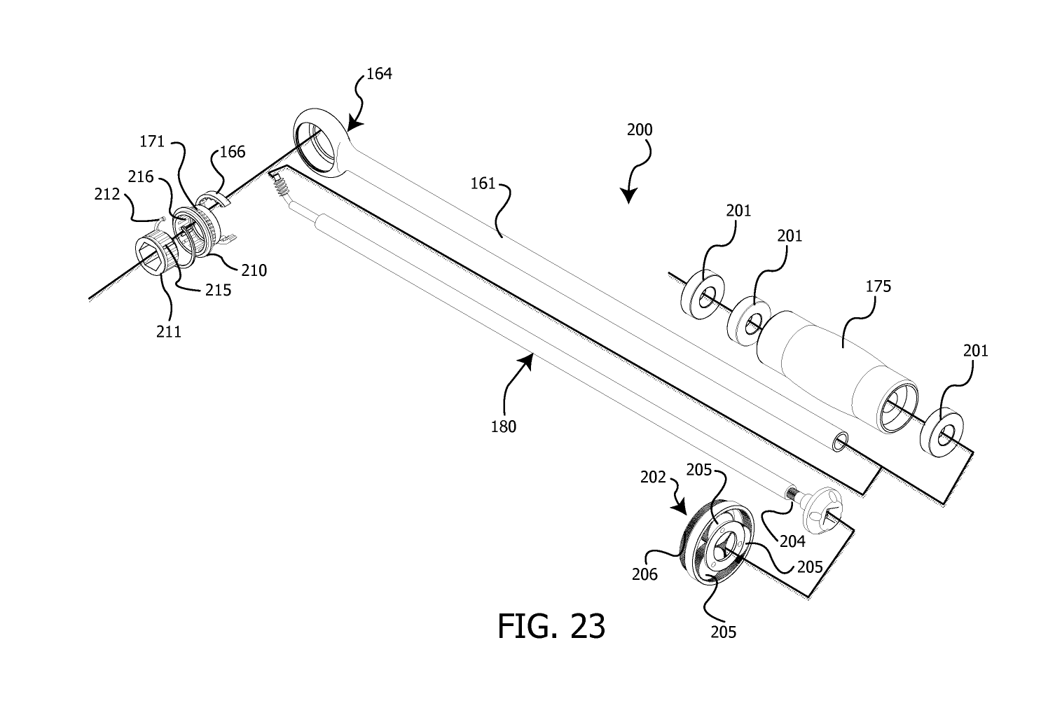

FIGS. 22 and 23 illustrate an alternate embodiment of a low-profile adjustable wrench 200 useful for loosening and tightening nuts and bolts of varying sizes. Although having a somewhat different design, adjustable wrench 200 is common to adjustable wrench 160 in that it shares fixture 161, working end 164, transmission 180, and handle 175, which has a somewhat different design compared to handle 175 of adjustable wrench 160. In this adjustable wrench 200, handle 175 is rotated to fixture 161 with bearings 201, and a drive planetary gear assembly 202 couples shaft 181 to handle 175. Drive planetary gear assembly 202 is an example of a reduction drive, which provides increased torque on shaft 181 per revolution of handle 175. Drive planetary gear assembly 202 is coupled between shaft 181 and handle 175 to allow fine adjustments in the rotation of shaft 181 and thus corresponding fine adjustments in the rotation of a wrench insert of working end 164. Drive planetary gear assembly 202 includes a drive sun gear 204 carried by shaft 181, a plurality of drive planet gears 205 coupled to drive sun gear 204 in meshing engagement, and a drive ring gear 206, coupled to handle 175, in meshing engagement with the plurality of drive planet gears 205. Other reduction drives or reduction gear assemblies can be used between handle 175 and shaft 181 without departing from the invention.

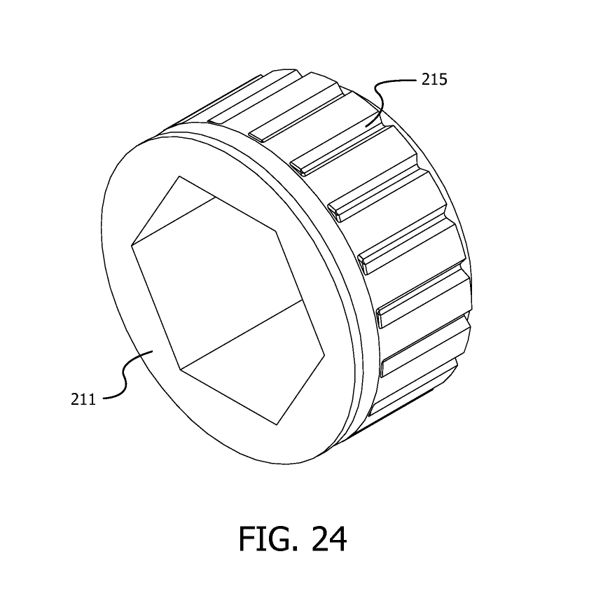

In FIG. 23, in adjustable wrench 200 working end 164 includes box 167 and bearing 166, as previously described, and two wrench inserts, including retention insert 210 and socket 211. Bearing 166 is captively retained in box 167, and retention insert 210 is inserted into box 167 and is retained for rotation therein by bearing 166, and is locked in place to box 167 with split-ring retainer 212. Retention insert 210 has the exterior circumferential gear 171 that couples the screw of drive assembly 180 in meshing engagement, and is a socket, a hollow cylinder, designed to accept socket 211 which, in turn, fits over the end of a nut or bolt head. In the use of adjustable wrench 200, rotation of retention insert 210 imparts corresponding rotation to socket 211 for loosening or tightening the fastener over which socket 211 is received. In FIGS. 23 and 24, exterior circumferential recesses or grooves 215 of socket 211 interlock with interior circumferential ribs 216 of retention insert 210 in FIG. 23 to prevent relative rotation between socket 211 and retention insert 210. In an alternate embodiment, socket 211 can be provided with exterior circumferential ribs, and retention insert 210 can be provided with the corresponding interior circumferential recesses or grooves. Retention insert 210 and socket 210, which are modular inserts, can have any preselected dimension or mechanical structures for engaging each other and the fastener requiring mechanical rotation.

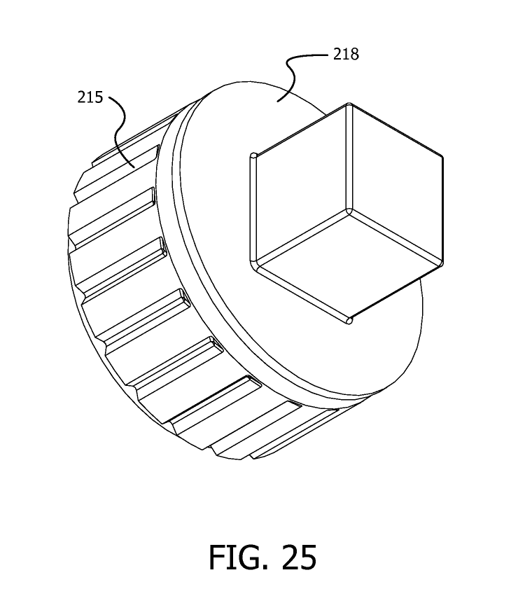

In FIGS. 22 and 24, socket 211, which is a modular wrench insert, is hollow cylinder that fits over the end of a nut or bolt head. Again socket 211 can have any preselected dimension. Socket 211 can be removed and replaced with other modular wrench inserts having various preselected dimensions or mechanical structure for any fastener requiring mechanical rotation, such as screwdriver head, a hex wrench, etc. An example of such a modular wrench insert is denoted by the reference character 218 in FIG. 25. In FIG. 25, wrench insert 218 has the same exterior circumferential recess or grooves 215, but rather than being a socket is a driver having a key for reception into a corresponding keyway of another wrench insert, such as a socket. Again, other selected wrench inserts can be used retention insert 210 without departing from the invention.

### D

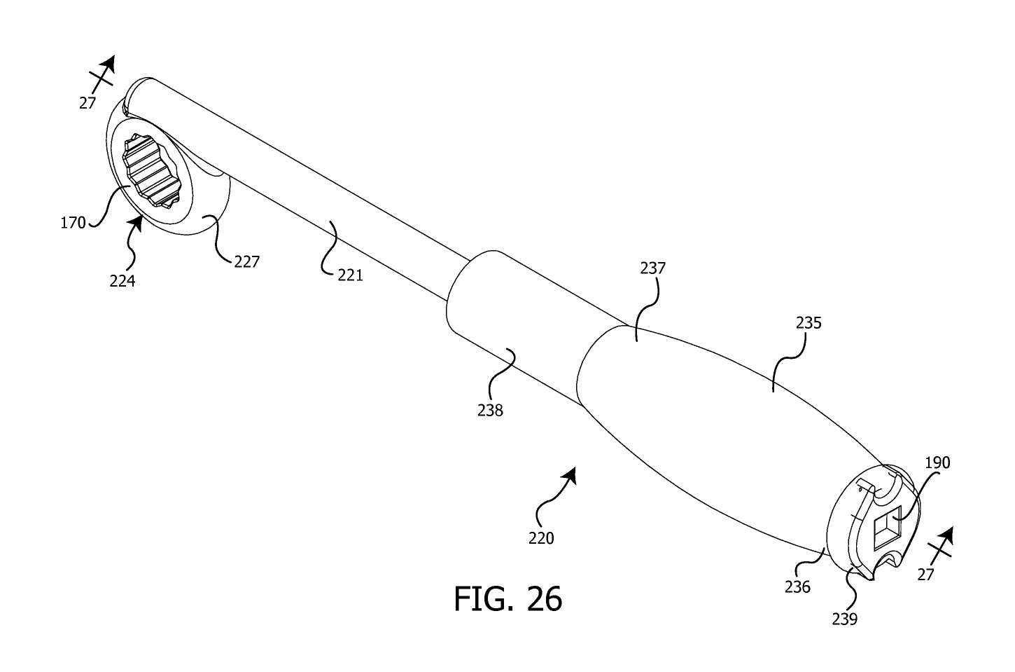

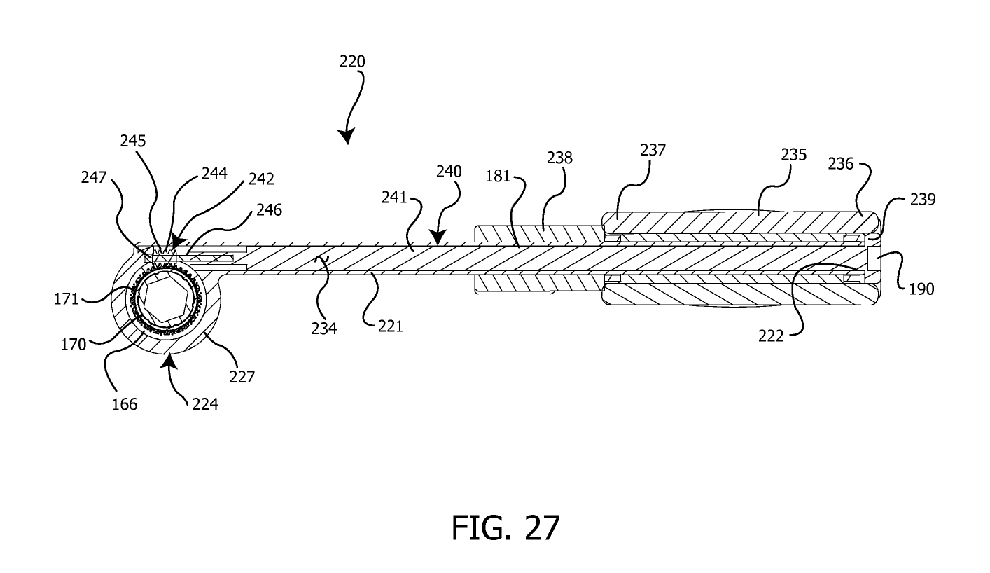

FIGS. 26 and 27 illustrate yet another embodiment of a low-profile adjustable wrench 220 useful for loosening and tightening nuts and bolts of varying sizes. Adjustable wrench 220 is formed of forged steel or an equivalent strong durable material. Adjustable wrench 220, which is an adjustable ring spanner or box wrench liked that of adjustable wrench 160, is a hand tool and includes elongate fixture 221 having a rear end 222 and an opposing forward working end 244. In FIG. 26, working end 244 is adjustable and includes the previously described C-shaped bearing 166 captively retained in a box 227, which is an annular body that is open on either side and that in this embodiment is offset to one side of fixture 221. The previously described wrench insert 170 is inserted into box 227 and is retained for rotation therein by bearing 166. Wrench insert 170, which has exterior circumferential gear 171, is a socket, a hollow cylinder, that fits over the end of a nut or bolt head. Fixture 221 is elongate and straight, and is cylindrical in shape from near to working end 244 to rear end 222. Fixture 221 is hollow, in which channel 234 extends through fixture 221 from box 227 of working end 244 to rear end 222. Channel 234 is open to box 227.

Fixture 221 carries handle 235. Handle 235 opposes working end 244, and is mounted for adjustment to fixture 221. Transmission 240 is coupled between handle 235 and working end 244, and transfers power from handle to working end wrench insert 170 for rotating wrench insert 170. Transmission 240 couples handle 235 to wrench insert 170 of working end 244, which again is an operative coupling, whereby adjustment of handle 235 urges corresponding adjustment of working end 104, namely, the corresponding rotation of wrench insert 170. In a further and more specific aspect, handle 235 is rotated to fixture 221 for rotational movement/adjustment, and transmission 240 couples handle 235 to wrench insert 170 of working end 244, again an operative coupling, whereby rotation of handle 235 urges corresponding adjustment of working end 244, namely, the corresponding rotation of wrench insert 170.

In FIG. 9, handle 235 has a rear end 236 and an opposing front end 237, encircles or otherwise circumscribes fixture 221, and rotates about fixture 221. Rear end 236 of handle 235 and rear end 222 of fixture 221 are juxtaposed, and handle 235 extends forwardly along fixture 221 from rear end 236 at rear end 222 of fixture 221 to front end 237 of handle 235 disposed at an intermediate location along the length of fixture 221 between rear end 222 and working end 244. A stationary grip 238 encircles or otherwise circumscribes fixture 221 forward of handle 235 between front end 237 of handle 235 and working end 244, and is received up against front end 237 of handle 235. Handle 235 has end cap 239, which is affixed to rear end 236 of handle 235 and extends over rear end 222 of fixture 221. Like end cap 179 of adjustable wrench 160, end cap 239 has socket 190. Beneficially, handle 235 is disposed for rotation by hand while gripping handle 235. If desired, a user my grip stationary grip 238 with one hand for stability, and rotate handle 235 with his other hand.

Transmission 240 includes a shaft 241 coupled between handle 235 and a gear assembly 242 coupled to working end 244. Shaft 241, which is enclosed in fixture 211, and which is an elongate member or rod for transmitting motion, extends through channel 234 from a screw 244 at its forward end at box 227 to its rearward end rigidly affixed to end cap 239, such as by welding, a press fit, or other rigid coupling. Shaft 241 is enclosed in channel 234. Screw 244, a gear, specifically a worm gear, is tangential to circumferential gear 171 of wrench insert 170, and is coupled to circumferential gear 171 in meshing engagement. Screw 244 and circumferential gear 171 form gear assembly 242. Screw 244 resides in recess 245 formed in the inner diameter of box 227 between a gap between opposed free ends 166A and 166B of bearing 166, and is affixed to and circumscribes a flexible segment 246, such as flexible cord, that extends tangentially into box 227 through the gap between free ends 166A and 166B of bearing 166 from the forward end of shaft 241. The outer end of flexible segment 246 on the far side of screw 244 is rotated in fitting 247 rigidly affixed to a counter-recess of recess 245. Flexible segment 246 is an extension of shaft 241 and is considered a part of shaft 241. Flexible segment 246 is affixed to the forward end of shaft 241, such as by welding or a press fitting engagement. Shaft 241 can rotate in channel 234. Screw 244 is the driven member of transmission 240, which is driven by handle 235, which is the drive member of transmission 240.

Shaft 241 is thus rotated to fixture 241 in channel 234, which, in turn, concurrently rotates screw 244 to working end 244 of fixture 221 at the forward end of shaft 241. Shaft 241 rotates about an axis that is parallel to and concentric with respect to the length of fixture 221 from screw 244 at its forward end at box 227 to its rearward end rigidly affixed to end cap 239. Lubrication, such as a lubricating oil or grease, can be applied in channel 234 and recess 245 to shaft 241 and gear assembly 242, respectively. Screw 244 rotates concurrently with the rotation of shaft 241, and the inherently flexible property of flexible segment 246 allows flexible segment 246 to constantly flex as needed as it rotates even though it rotates about the axis of rotation of shaft 241. The coupling of flexible segment 246 between the forward end of shaft 241 and fitting 247 retain screw 244 in place.

The meshing engagement of screw 244 to circumferential gear 171 operatively couples screw 244 to wrench insert 170, whereby rotation of screw 244 urges corresponding rotation of wrench insert 170. Rotation of handle 235 concurrently rotates shaft 241 which rotates screw 244. Rotation of screw 244 imparts corresponding rotation to wrench insert 170, and the rotation of wrench insert 170 is considered to be an adjustment of working end 244. And so shaft 241 operatively couples handle 235 to screw 244, the driven member of transmission 240, which, in turn, is operatively coupled to the movable component of working end 244, wrench insert 170, whereby rotation of handle 235 urges corresponding rotation of screw 244 for rotating wrench insert 170. Rotation of handle 235 in one direction, such as the clockwise direction, urges rotation of wrench insert 170 in first direction, and rotation of handle 235 in the opposite direction, the counterclockwise direction, urges rotation of wrench insert 170 in the opposite direction.

And so adjustable wrench 220 includes fixture 221 having working end 244 and opposing handle 235 mounted for adjustment to fixture 221. Transmission 240 operatively couples handle 235 to the movable part of working end 244, wrench insert 170, in which adjustment of handle 235 urges corresponding adjustment of working end 244, namely, the rotation of wrench insert 170. More specifically, handle 235 is rotated to fixture 221 and transmission 240 operatively couples handle 235 to wrench insert 170 of working end 244, in which rotation of handle 235 urges corresponding adjustment of working end 244, namely, the rotation of wrench insert 170.

In common with adjustable wrench 160, adjustable wrench 220 can be operated in areas that lack space to properly use conventional wrenches. Adjustable wrench 220 is particularly well suited for application that require hand tightened fasteners. By twisting rotating handle 235 adjustable wrench 220 mechanically rotates wrench insert 170 to rotate a fastener inserted into wrench insert 170. The user can then use adjustable wrench 220 in a radial motion, apart from twisting rotating handle 235, to apply desired leverage or torque. Whereas, common wrenches work solely in a radial motion, adjustable wrench works in a radial motion and from twisting rotating handle 235. Again, handle 235 is disposed for rotation by hand while gripping handle 235, and a user my grip stationary grip 238 with one hand for stability, and rotate handle 235 with his other hand. In FIGS. 10-12, wrench insert 170, which is a modular insert, is a socket, a hollow cylinder that fits over the end of a nut or bolt head. Wrench insert 170 can have any preselected dimension and other modular wrench inserts can be used as discussed above in connection with adjustable wrench 160.

In FIGS. 26 and 27, end cap 239 is formed with socket 190, which can accept the key of a handle or handled implement, such as handled implement 194 previously discussed, an impact wrench, or other motorized driver, for aiding a user in rotating handle 235.

### E

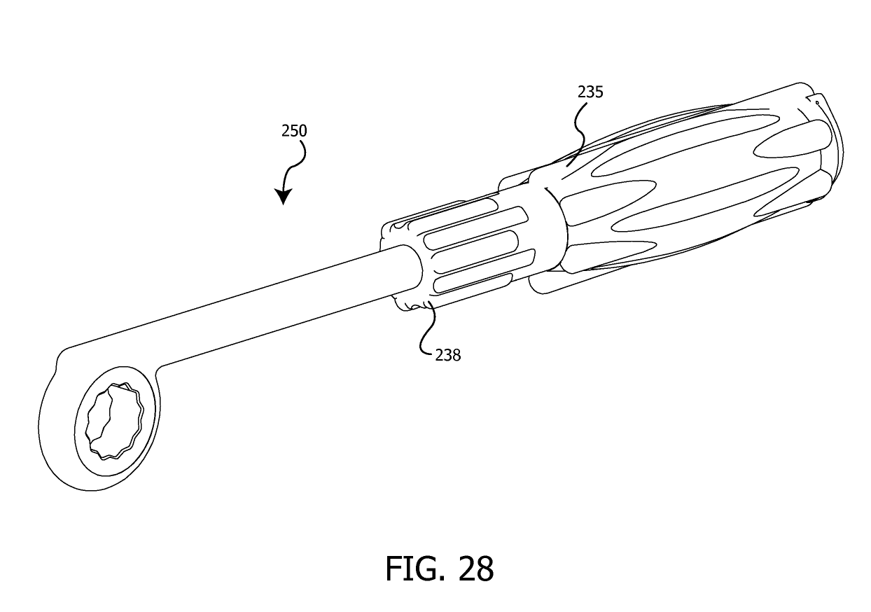

FIG. 28 illustrates still another alternate embodiment of a low profile adjustable wrench 250, which is identical in every respect to adjustable wrench 220 with two differences. In adjustable wrench 260, handle 235 and grip 238 each have contoured outer surfaces to aid a user in gripping them by hand. The contours in handle 235 and grip 238 can be formed directly into handle 235 and grip 238, can be formed in attached sleeves, such as rubber sleeves, or can be formed as over-molded features fashioned of a rubber or rubberized material for gripping.

### F

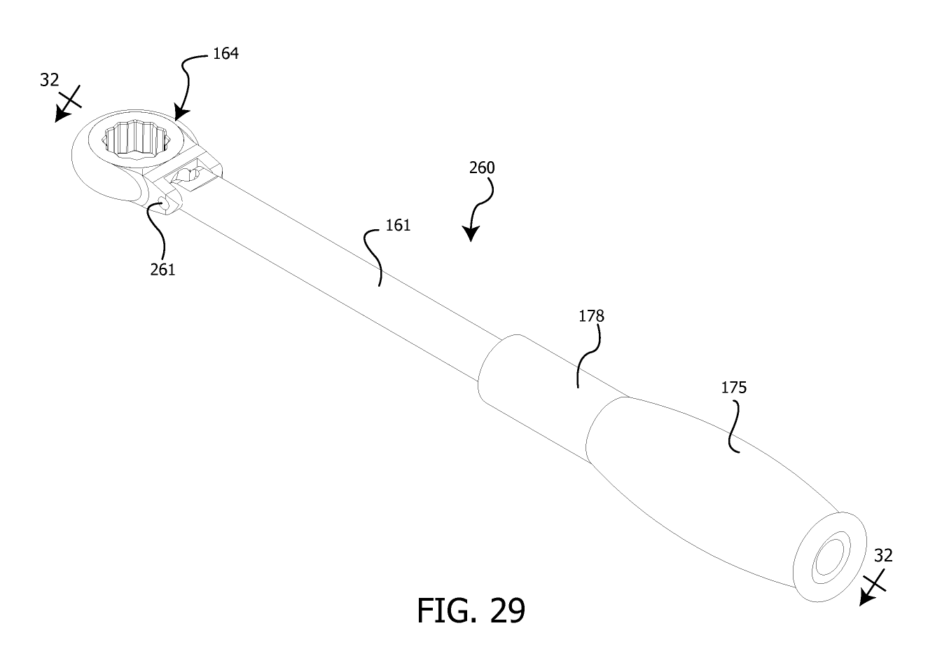

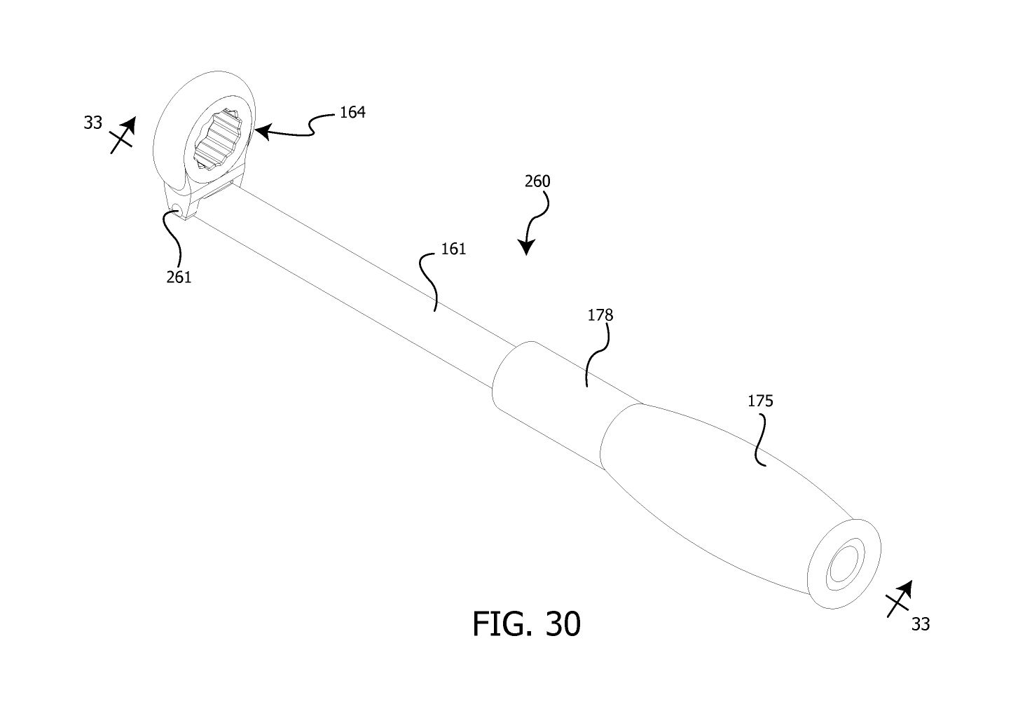

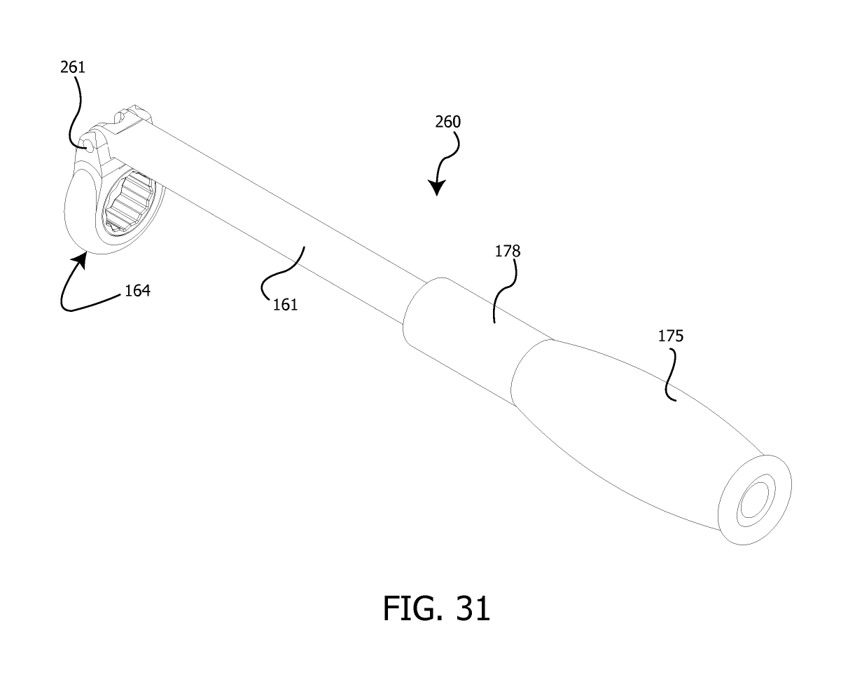

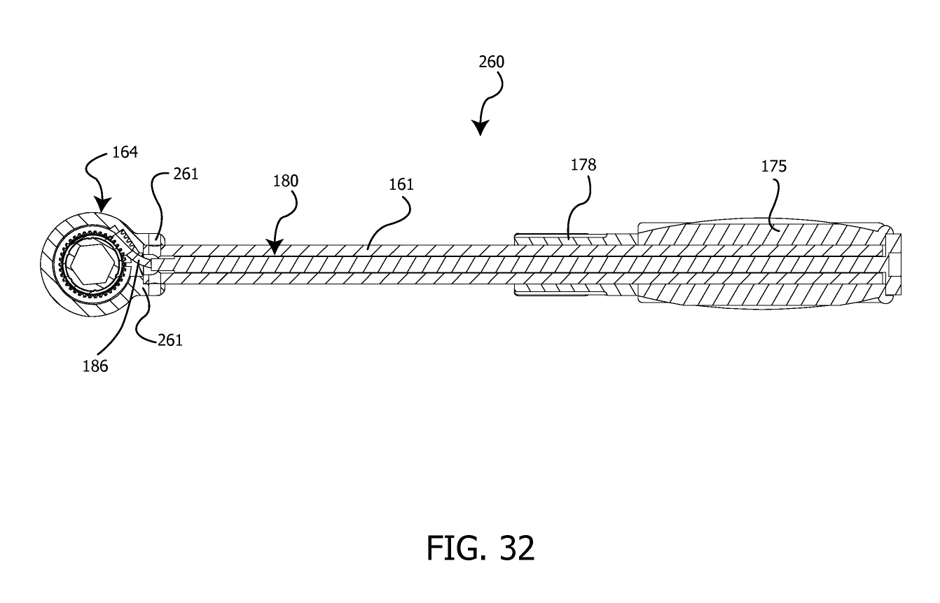

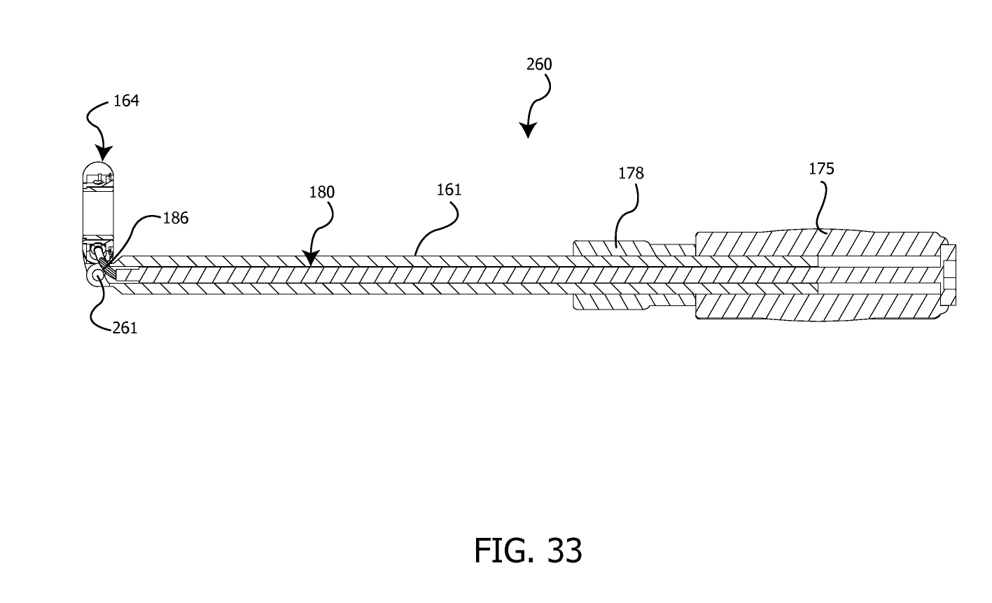

FIGS. 29-33 illustrate yet still a further embodiment of a low-profile adjustable wrench 260 useful for loosening and tightening nuts and bolts of varying sizes. In common with, adjustable wrench 160, adjustable wrench 260 shares fixture 161 working end 164, transmission 180, referenced in FIGS. 32 and 33, handle 175, and grip 178. In adjustable wrench 160, working end 164 is immovable. In adjustable wrench 260, working end 164 is pivoted to the forward end of fixture 161 with pivot pins 261 to permit pivotal movement of working end 164. FIG. 29 shows working end 164 as it would appear in a central or intermediate position, and FIGS. 30 and 31 are perspective views corresponding to FIG. 29 illustrating working end 164 pivoted to either side of the intermediate position in FIG. 29. The ability to pivot working end 164 relative to fixture 161 allow the user to access a fastener from a variety of angles. In FIGS. 32 and 33, flexible segment 186 extends between working end 164 and the forward end of fixture 161 across the pivot joint pivotally connecting working end 164 to fixture 161. Flexible segment 186 flexes with the pivoting action of working end 164 at the pivot joint and the operation of transmission 180 is retained regardless of the position of working end 164, according to the principle of the invention. Other than this difference, the discussion of adjustable wrench 160 applies in every respect to adjustable wrench 260.

### G

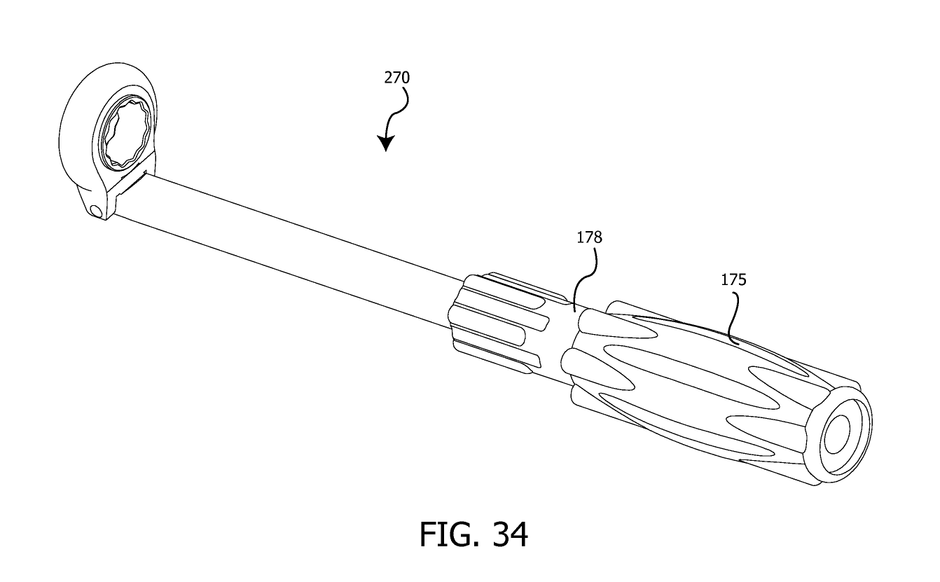

FIG. 34 illustrates a further alternate embodiment of a low profile adjustable wrench 270, which is identical in every respect to adjustable wrench 260 with two differences. In adjustable wrench 270, handle 175 and grip 178 each have contoured outer surfaces to aid a user in gripping them by hand. The contours in handle 175 and grip 178 can be formed directly into handle 175 and grip 178, can be formed in attached sleeves, such as rubber sleeves, or can be formed as over-molded features fashioned of a rubber or rubberized material for gripping.

### §II. Pliers and Shears

### A

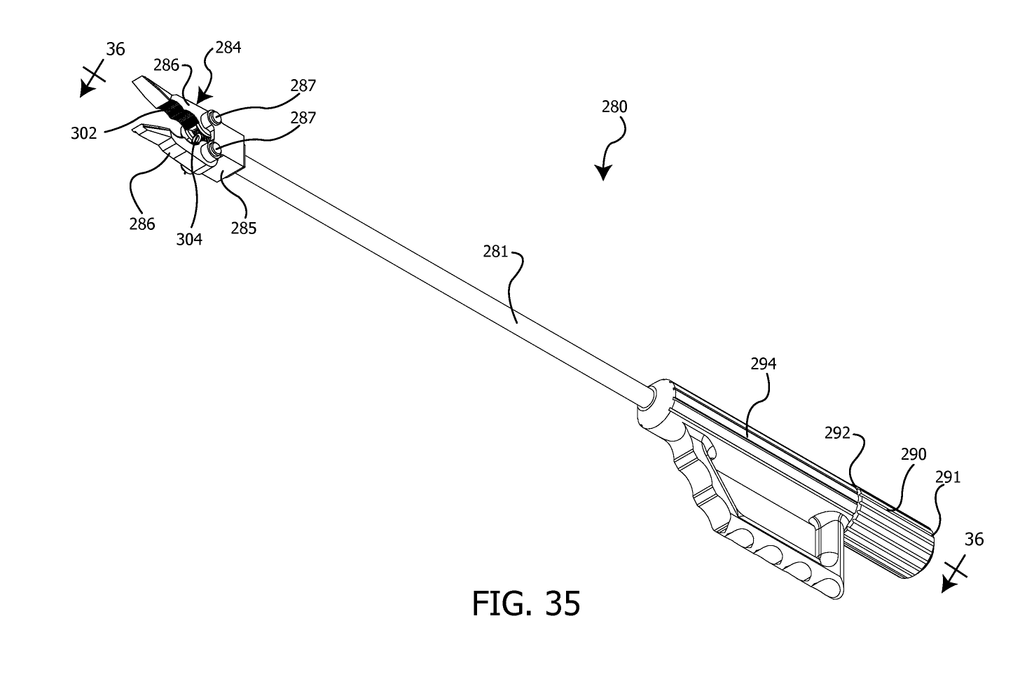

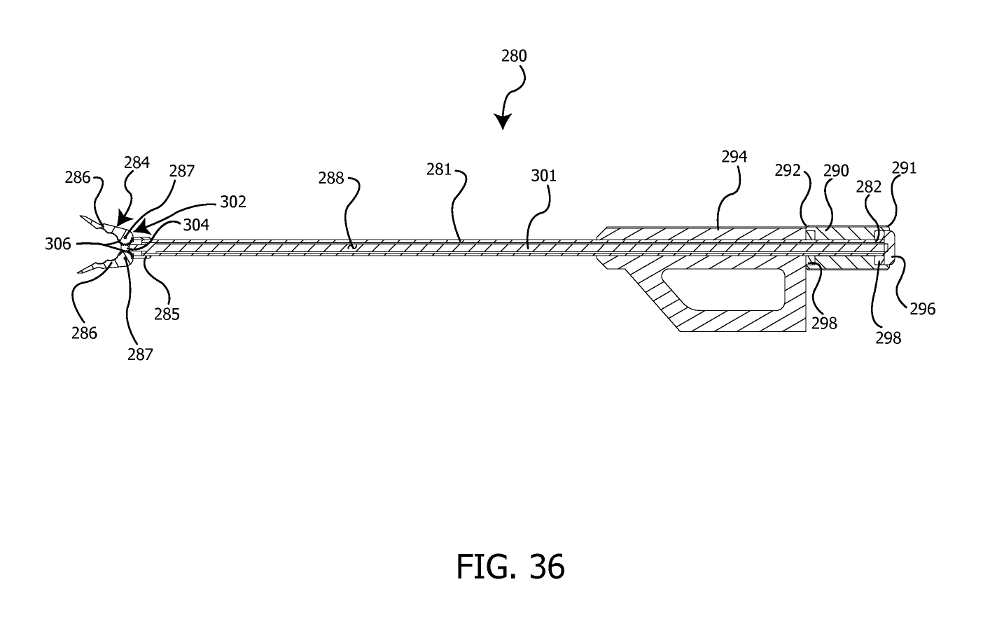

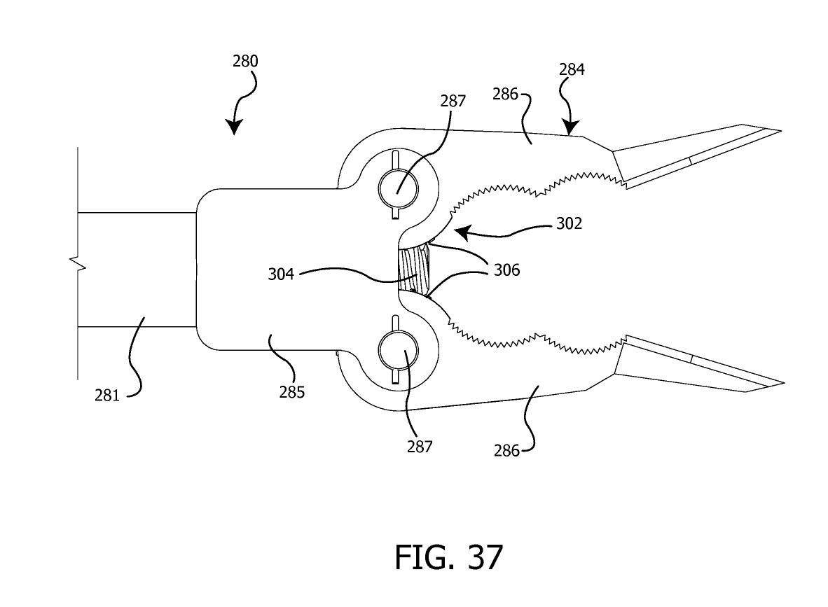

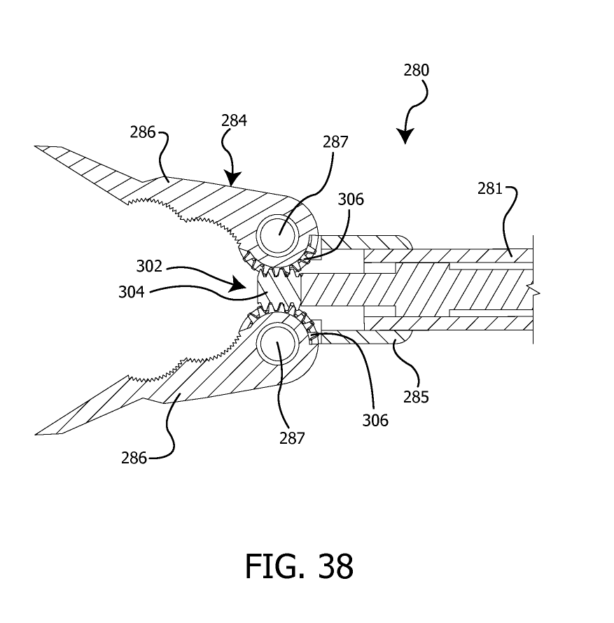

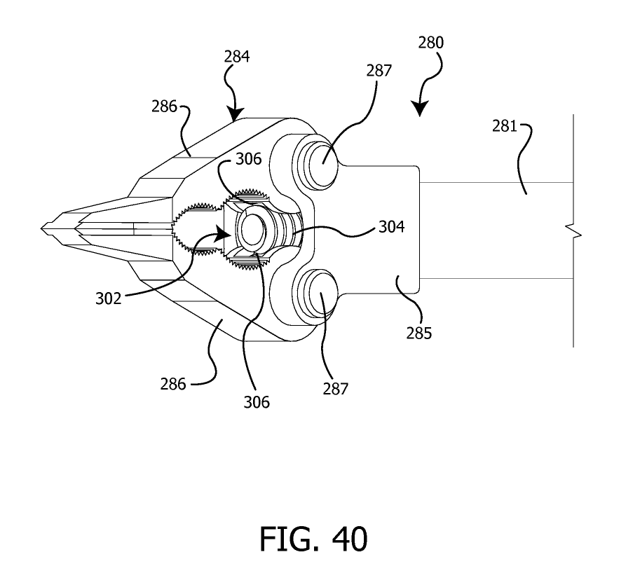

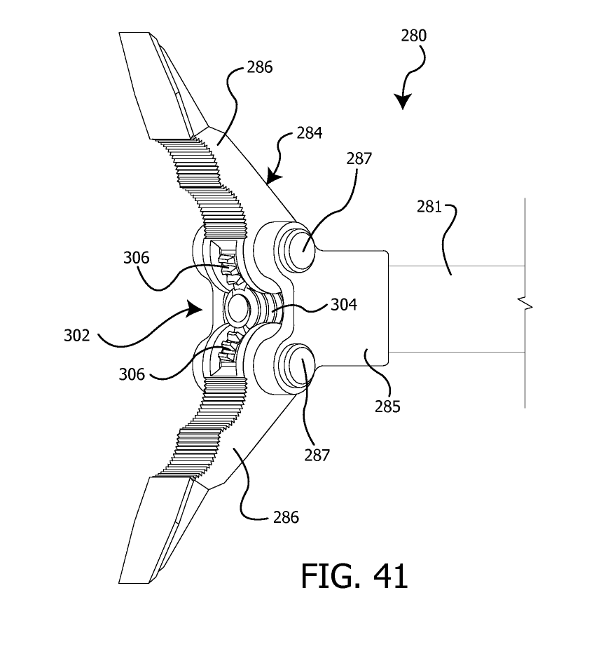

FIGS. 35 and 36 illustrate pliers 280 used to hold objects firmly. Pliers 280 is formed of forged steel or an equivalent strong durable material. Pliers 280, which is an adjustable hand tool, includes elongate fixture 281 having a rear end 282 and an opposing forward working end 283. Looking also to FIGS. 37, 38, 40, and 41, working end 284 includes end section 285, and co-acting movable jaws 286 mounted to end section 285. End section 285 is rigidly affixed to the forward end of fixture 281, such as by welding or other mechanical joinery. Jaws 286 are identical in every respect, are each pivoted to end section 285 with a pivot pin 287, and are co-acting in which they pivot back and forth between a closed position in FIG. 40 for holding an object and an open position in FIG. 41 for releasing an object. In FIG. 36, fixture 281 is elongate and straight, and is cylindrical in shape from end section 285 to rear end 282. Fixture 281 is hollow, in which channel 288 extends through fixture 281 from working end 284 to rear end 282. Channel 234 is open to jaws 286 and 287.

Fixture 281 carries handle 290. Handle 290 opposes working end 284, and is mounted for adjustment to fixture 281. Transmission 300 couples handle 290 to jaws 286 of working end 284. Transmission 300 is coupled between handle 290 and working end 284, and transfers power from handle 290 to working end 284 for pivoting jaws 286 back and forth between their closed positions in FIG. 40 defining the closed position and working end 284 and their open positions in FIG. 41 defining the open position of working end 284. The coupling of transmission to handle 290 and jaws 286 of working end 284 is in operative coupling, whereby adjustment of handle 290 urges corresponding adjustment of working end 284, namely, the corresponding movement of jaws 286 between their closed positions in FIG. 40 and their open positions in FIG. 41. In a further and more specific aspect, handle 290 is rotated to fixture 281 for rotational movement/adjustment, and transmission 300 couples handle 290 to jaws 286 of working end 284, whereby rotation of handle 290 urges corresponding adjustment of working end 284, namely, the corresponding movement of jaws 286 between their closed positions in FIG. 40 and their open positions in FIG. 41.

In FIG. 36, handle 290 has a rear end 291 and an opposing front end 292, encircles or otherwise circumscribes fixture 281, and rotates about fixture 281. Rear end 291 of handle 290 and rear end 282 of fixture 281 are juxtaposed, and handle 290 extends forwardly along fixture 281 from rear end 291 at rear end 282 of fixture 281 to front end 292 of handle 290 along the length of fixture 281 near rear end 282. A stationary grip 294 encircles or otherwise circumscribes fixture 281 forward of handle 290 between front end 292 of handle 290 and working end 284, and is received up against front end 292 of handle 290. Handle 290 has end cap 296, which is affixed to rear end 291 of handle 290 and extends over rear end 282 of fixture 281. Like end cap 179 of adjustable wrench 160, end cap 296 can be formed with a socket to receive a handled implement for aiding a user in rotating handle 290. Beneficially, handle 290 is disposed for rotation by hand while gripping handle 290. If desired, a user my grip stationary grip 296 with one hand for stability, and rotate handle 290 with his other hand. Stationary grip 296 has a hand shield in this embodiment. In FIG. 36, handle 290 is rotated to fixture 281 with bearings 298.

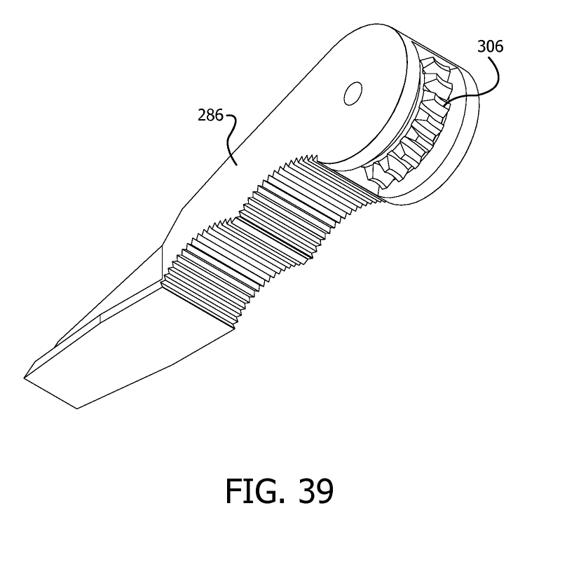

Transmission 300 includes a shaft 301 coupled between handle 290 and a gear assembly 302 coupled to working end 284. Shaft 301, which is enclosed in fixture 281 and which is an elongate member or rod for transmitting motion, extends through channel 288 from a screw 304 at its forward end at end section 285 and jaws 286 at working end 284 to its rearward end rigidly affixed to end cap 296, such as by welding, a press fit, or other rigid coupling. Shaft 301 is enclosed in channel 288. Screw 304, a gear, specifically a worm gear, is disposed between jaws 286 in FIGS. 35-38, 40, and 41, and is concurrently coupled to radial gears 306 of the respective jaws 286 in meshing engagement in FIGS. 36-38, 40 and 41. FIG. 39 is an enlarged perspective view of a jaw 286 illustrating radial gear 306 formed near its pivotal connection point that pivotally connects to end section 285. Screw 304 and radial gears 306 form gear assembly 302. Screw 304 resides between radial gears 306, is tangential relative to each radial gear 306, and is coupled to each radial gear 306 in meshing engagement, which is an operative coupling. Shaft 301 can rotate in channel 288, which, in turn, rotates screw 304 to fixture 281. Screw 304 is the driven member of transmission 300, which is driven by handle 290, which is the drive member of transmission 300.

Shaft 301 is thus rotated to fixture 281 in channel 288, which, in turn, concurrently rotates screw 304 to working end 284 of fixture 281 at the forward end of shaft 301. Shaft 301 and screw 304 concurrently rotate about an axis that is parallel to and concentric with respect to the length of fixture 281 from screw 304 at its forward end at working end 284 to its rearward end rigidly affixed to end cap 296. Lubrication, such as a lubricating oil or grease, can be applied in channel 288 and to screw 304. Screw 304 rotates concurrently with the rotation of shaft 301. The meshing engagement of screw 304 to radial gears 306 of the respective jaws 286 operatively couples screw 304 jaws 286, whereby rotation of screw 304 urges corresponding pivotal movement of jaws 286 between their closed positions in FIG. 40 and their open positions in FIG. 41. Rotation of handle 290 concurrently rotates shaft 301 which rotates screw 304. Rotation of screw 304 concurrently pivots jaws 286, and the pivotal movement of jaws 286 is considered to be an adjustment of working end 284. And so shaft 301 operatively couples handle 290 to screw 304, the driven member of transmission 300, which, in turn, is operatively coupled to the movable components of working end 284, jaws 286, whereby rotation of handle 290 urges corresponding pivoting of jaws 286. Rotation of handle 290 in one direction, such as the clockwise direction, pivots jaws 286 closed in FIG. 40, and rotation of handle 290 in the opposite direction, the counterclockwise direction, pivots jaws 286 open in FIG. 41.

And so adjustable wrench 280 includes fixture 281 having working end 284 and opposing handle 290 mounted for adjustment to fixture 281. Transmission 300 operatively couples handle 290 to the movable parts of working end 284, jaws 286, in which adjustment of handle 290 urges corresponding adjustment of working end 284, namely, the pivoting of jaws 286 between their closed positions in FIG. 40 corresponding to the closed position of working end 284 and their open positions in FIG. 41 corresponding to the open position of working end 284. More specifically, handle 290 is rotated to fixture 281 and transmission 300 operatively couples handle 290 to jaws 286 of working end 284, in which rotation of handle 290 urges corresponding adjustment of working end 284, namely, the pivoting of jaws 286.

Instead of squeezing or spreading levers as with conventional pliers, jaws 286 are opened and closed simply by rotating handle 290. At any given point, when rotation of handle 290 ceases, jaws 286 are automatically locked into the current position via the meshing coupling of screw 304 to radial gears 306. This singular action enables the user to achieve the same results of conventional pliers with significantly less effort, especially compared to other styles of locking pliers. Other benefits include eliminating the need to apply constant pressure on the levers while still remaining in contact with the object. Additionally, the amount of force between jaws 286 is no longer limited to the user's grip.

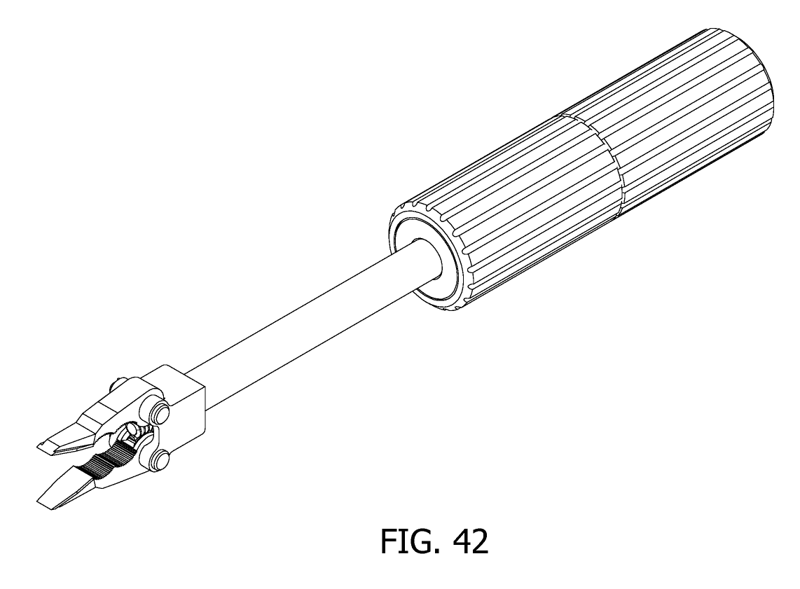

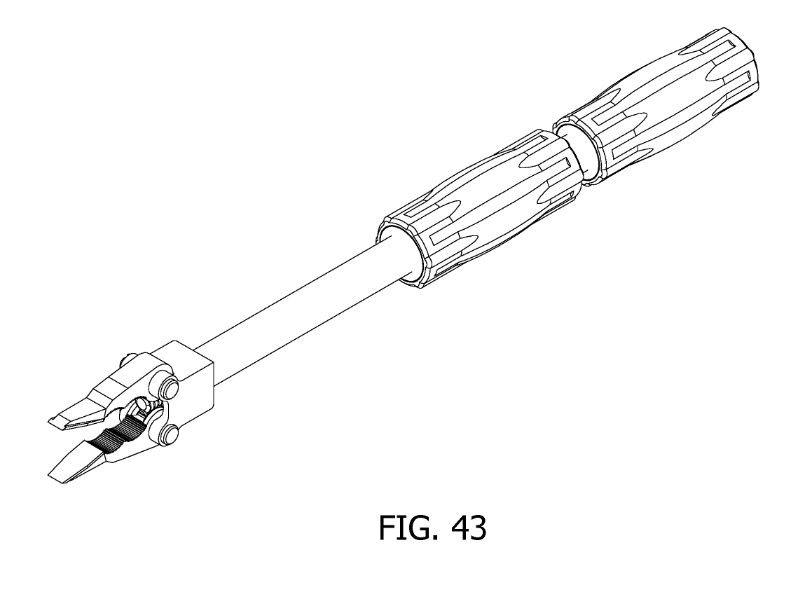

In conventional pliers, the longer the pair of pliers are the wider the handle levers have to open making them difficult to fit into tight spaces. Because jaws 286 operate by rotating handle 290, pliers 280 can be made to any length allowing it's profile to fit into confined spaces. As a matter of example, FIGS. 42 and 43 show alternate embodiments of pliers constructed according to pliers 280, but are shorter in overall length and include differently-shaped rotating handles and stationary grips. In fact, pliers 280 can be constructed to significantly longer lengths than conventional pliers all while enhancing reach and leverage. Also, pliers 280 can be repositioned on the fastener with significantly less effort from the user.

An additional advantage to pliers 280 is to utilize them as a spreading device in which a universal set of jaws knurled on both the interior and exterior surfaces enables pliers 280 to work as both clamping and spreading pliers. In one embodiment, jaws 286 can be transposed to function more effectively in this regard.

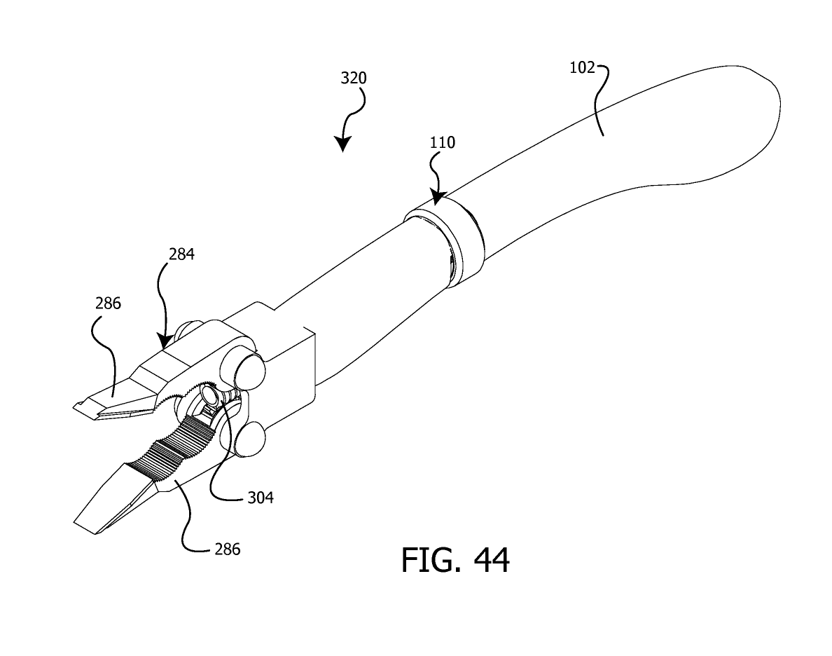

Another pliers embodiment places the rotating drive member above a stationary handle allowing the user to operate the pliers with his thumb and forefinger enabling one-handed operation, as in adjustable wrench 100. FIG. 44 illustrates just such pliers 320. In FIG. 44, working end 104 of adjustable wrench 100 is replaced with working end 284 of pliers 280. While gripping stationary handle 102, a user rotates drive member 110 with their thumb and forefinger enabling one-handed operation. In response to rotating drive member 110 as in adjustable wrench 100, the transmission 120, which is not shown in FIG. 44 and which is discussed in detail above in connection with adjustable wrench 100), rotates screw 304 which, in turn, pivotally operates jaws 286 in the way described in the discussion of pliers 280.

In the pliers disclosed above, jaws 286 are each movable. In an alternate embodiment, one jaw 286 can be a fixed jaw and the other jaw 286 can be a movable jaw, in which screw 304 is coupled to the radial gear 306 of only one jaw 286 in meshing engagement, whereby rotation of handle 290 pivots the one movable jaw 286 between open and closed positions relative to the fixed or stationary jaw.

The pliers disclosed herein have incredibly diverse applications simply by adjusting the scale and constructing the pliers with different types of jaws, including, but not limited to, needle-nose, pincers, crimping, linemans, diagonal, and other types of pliers jaws. Embodiments could include designs targeted for medical applications, work with small electronic components, large scale industrial use, etc.

### B

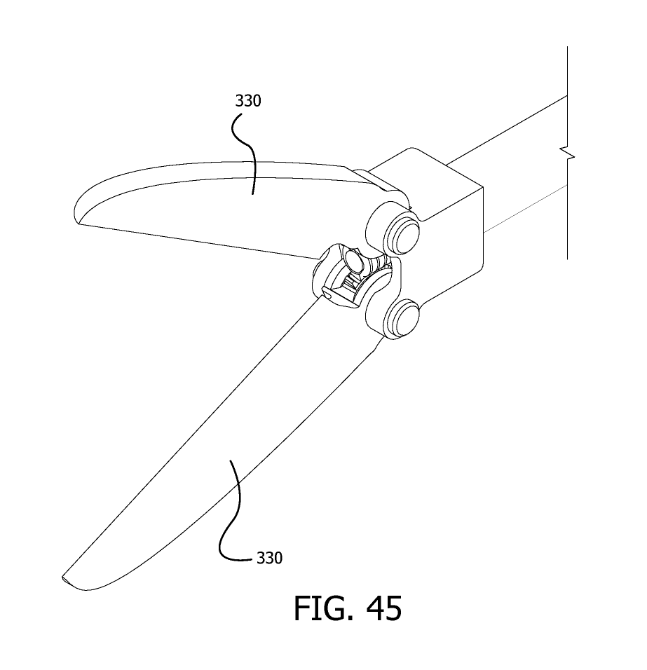

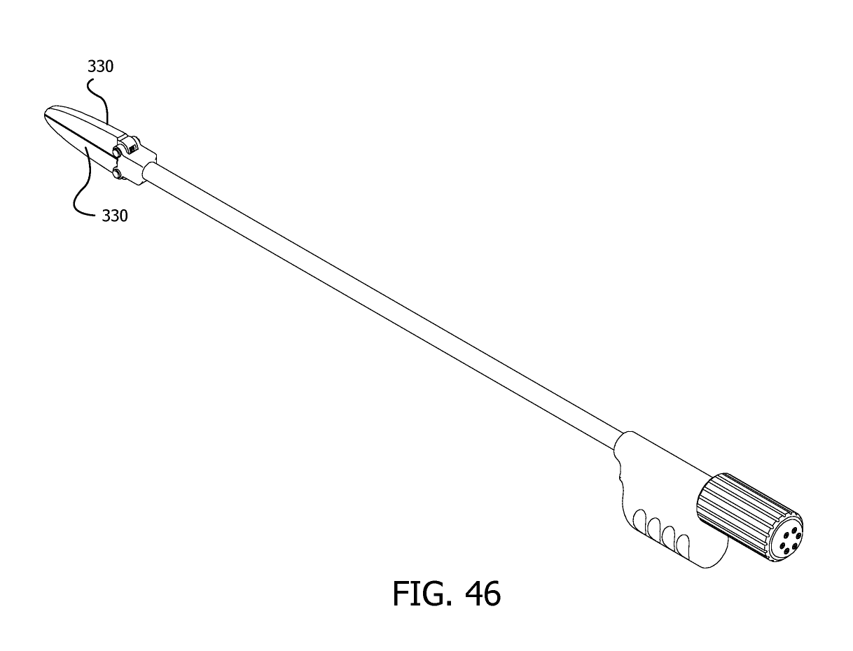

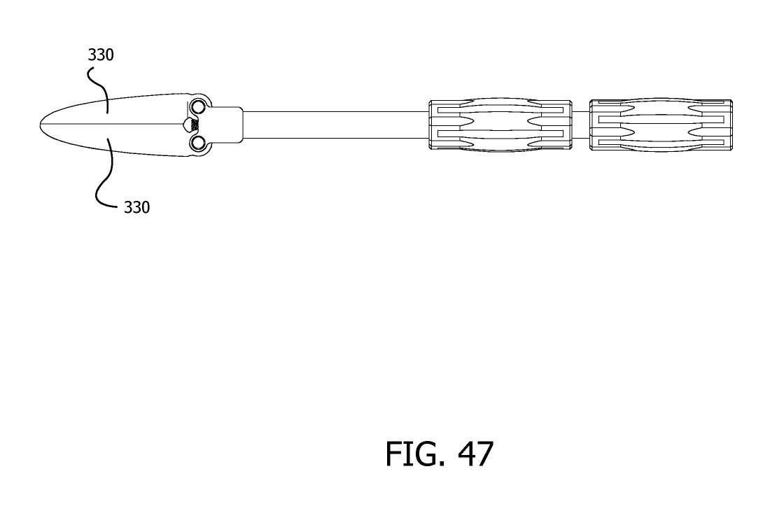

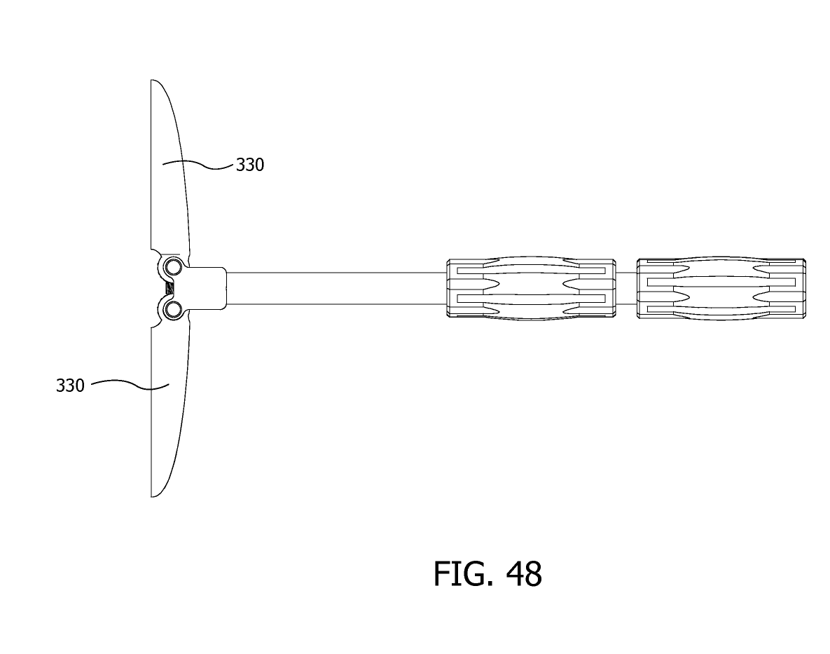

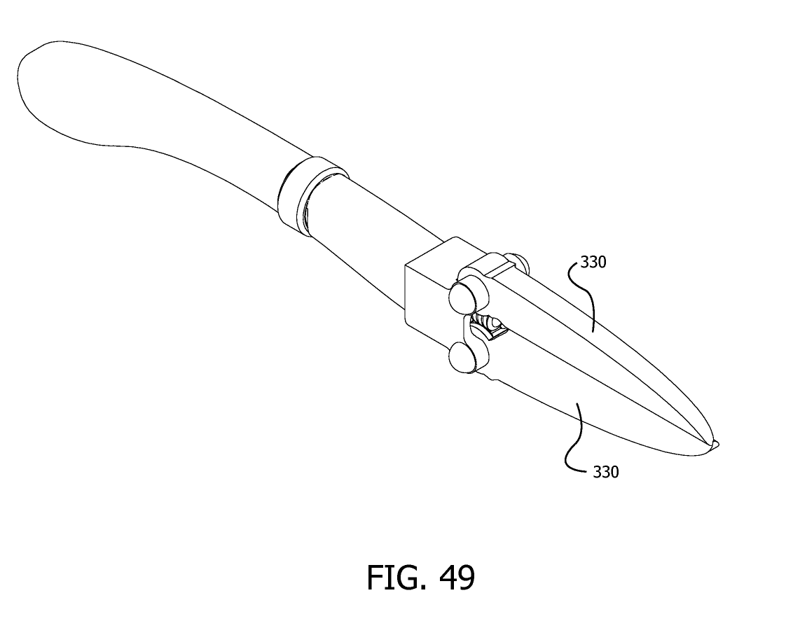

Rather than pliers jaws, still other types of jaws can be used, such as cutting blades or shears jaws for use in cutting objects. As a matter of example, FIG. 45 is an enlarged perspective view of working end 284 of pliers 280. In place of jaws 286 are shears jaws or cutting blades 330 forming shears useful for cutting via the operation of the rotating handle. FIG. 45 shows cutting blades 330 as they would appear open, and FIG. 46 shows blades 330 as they would appear closed for cutting. The pliers jaws of the other pliers embodiments may be similarly replaced with cutting blades 330. To illustrate this as a matter of example, FIG. 47 is a side elevation view of the embodiment of FIG. 43 showing cutting blades 330 in place of the pliers jaws, and which are opened and closed by operating the rotating handle. FIG. 47 shows cutting blades 330 as they would appear closed, and FIG. 48 shows blades 330 as they would appear closed for cutting. FIG. 49 is a perspective view of the embodiment of FIG. 44 showing cutting blades 330 in place of the pliers jaws, and which are opened and closed by gripping the stationary handle and rotating the drive member with the thumb and forefinger enabling one-handed operation. The mechanical advantage of a rotating handle or a rotating drive member operatively coupled to pliers jaws or cutting blades with the corresponding transmissions as disclosed herein provide stability and control, and the ability to access difficult to reach areas.

### §III. Conclusion

Those having regard for the art will readily appreciate that exemplary adjustable wrenches, pliers, and shears are disclosed. The various embodiments are easy to construct, easy to use, and safe, and beneficially provide the mechanical advantage of drive members and handles operatively coupled to the movable part or parts of a working end of a hand tool, such as a co-acting jaw of a wrench, the rotating wrench insert of a wrench, or co-acting jaws, such as pliers jaws, shears jaws, etc. The mechanical advantage offered by the drive members and handles provides stability and control of operation, and the ability to operate in tight and difficult to reach areas. Those having regard for the art will readily appreciate that the various embodiments can be scalable to meet any need, including consumer and industrial applications.

The invention has been described above with reference to illustrative embodiments. However, those skilled in the art will recognize that changes and modifications may be made to the embodiments without departing from the nature and scope of the invention. Various changes and modifications to the embodiments herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. A hand tool, comprising:
a fixture having an adjustable working end and an opposing handle rotated to the fixture; and
a transmission coupling the handle to the adjustable working end, whereby rotation of the handle urges corresponding adjustment of the adjustable working end.

2. The hand tool according to claim 1, wherein the transmission comprises a shaft coupled between the handle and a gear assembly coupled to the adjustable working end.

3. The hand tool according to claim 2, wherein the gear assembly comprises a screw mounted to the shaft coupled to at least one gear of the adjustable working end in meshing engagement.

4. The hand tool according to claim 3, wherein the handle circumscribes the fixture.

5. The hand tool according to claim 4, wherein the transmission is enclosed within the fixture.

6. A hand tool, comprising:
a handle rotated to a fixture having an end section;
a wrench insert rotated to the end section;
a driven member rotated to the end section;
the driven member is coupled the wrench insert, whereby rotation of the driven member urges corresponding rotation of the wrench insert; and
the handle is coupled to the driven member, whereby rotation of the handle urges corresponding rotation of the driven member.

7. The hand tool according to claim 38, further comprising a shaft coupling the handle to the driven member, whereby rotation of the handle urges corresponding rotation of the shaft, which, in turn, urges the corresponding rotation of the driven member.

8. The hand tool according to claim 7, further comprising a drive planetary gear assembly coupling the shaft to the handle including a drive sun gear carried by the shaft, a plurality of drive planet gears coupled to the drive sun gear in meshing engagement, and a drive ring gear, coupled to the handle, in meshing engagement with the plurality of drive planet gears.

9. The hand tool according to claim 7, wherein the handle circumscribes the fixture and is disposed for rotation by hand.

10. The hand tool according to claim 7, wherein the shaft extends through the fixture from the driven member to the handle.

11. The hand tool according to claim 7, wherein the driven member is a screw coupled to a gear of the wrench insert in meshing engagement.

12. The hand tool according to claim 10, wherein the shaft is enclosed within the fixture.

13. A hand tool, comprising:
a handle rotated to a fixture having an end section;
co-acting movable jaws mounted to the end section;
a driven member rotated to the end section;
the driven member is coupled the co-acting movable jaws, whereby rotation of the driven member urges corresponding movement of the co-acting movable jaws; and
the handle is coupled to the driven member, whereby rotation of the handle urges corresponding rotation of the driven member.

14. The hand tool according to claim 13, further comprising a shaft couples the handle to the driven member, in which rotation of the handle urges corresponding rotation of the shaft, which, in turn, urges the corresponding rotation of the driven member.

15. The hand tool according to claim 14, wherein the handle circumscribes the fixture and is disposed for rotation by hand.

16. The hand tool according to claim 15, wherein the shaft extends through the fixture from the driven member to the handle.

17. The hand tool according to claim 16, wherein the driven member is a screw coupled to a gear of each one of the co-acting movable jaws in meshing engagement.

18. The hand tool according to claim 14, wherein the shaft is enclosed within the fixture.
